(19) United States
(12) Patent Application Publication
(10) Pub. No.: US 2024/0410061 A1
(43) Pub. Date: Dec. 12, 2024

(54) INTEGRATED WATER CAPTURE AND ELECTROLYSIS

(71) Applicants: Jarrod WARD, Sydney (AU); Gerard REITER, Sydney (AU)

(72) Inventors: Jarrod WARD, Sydney (AU); Gerard REITER, Sydney (AU)

(21) Appl. No.: 18/735,332

(22) Filed: Jun. 6, 2024

(30) Foreign Application Priority Data
Jun. 6, 2023 (AU) 2023901788
Jun. 6, 2023 (AU) 2023901790

(51) Int. Cl. C25B 1/04; C25B 9/67; C25B 15/021; C25B 15/08; H01M 16/00

(52) U.S. Cl. CPC C25B 1/04; C25B 9/67; C25B 15/021; C25B 15/08; H01M 16/003

(57) ABSTRACT

Provided herein is an integrated water capture and electrolysis system for enhancing the efficiency of hydrogen production from water by an electrolyser, the method comprising operatively associating an atmospheric water capture apparatus with the electrolyser such that heat utilisation is relatively maximised and current density is relatively minimised. In an embodiment, the atmospheric water capture apparatus produces water, at least some of which is used for cooling a solar cell prior to injection into the electrolyser.

### CROSS-REFERENCE TO RELATED APPLICATIONS

The present application claims priority from Australian Provisional Patent Application No. 2023901788, filed on 6 Jun. 2023, and Australian Provisional Patent Application No. 2023901790, filed on 6 Jun. 2023. The entire contents of both applications are incorporated herein by reference.

### FIELD OF THE INVENTION

The present invention relates to a system for the collection of atmospheric water integrated with an electrolyser for the production of hydrogen. More specifically, the invention relates to improved systems and methods for extracting relatively pure water from water vapor and integration with an alkaline or PEM electrolyser absent a water purification step. Although the invention will be described herein with reference to such a preferred embodiment, it will be appreciated that the invention is not limited to this particular aspect or field of endeavour.

The present invention also relates, in various embodiments, to technology configured to enable improved operation of electrolyser-based hydrogen generation systems. For example, the technology has been developed to operate in a scenario where an electrolyser system is powered via a renewable energy source, such as one or more photovoltaic cells, tidal, wind, geothermal or other renewable energy resource. In some embodiments, the technology provides arrangements which inhibit reverse operation of an electrolyser as a result of input voltage drop. Other embodiments additionally/alternately provide for improved electrolyser cell management, thereby to better account for variations in renewable energy production. While some embodiments will be described herein with particular reference to those applications, it will be appreciated that the invention is not limited to such a field of use, and is applicable in broader contexts.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Applicant's proprietary water making method and apparatus is described in, for instance, PCT international patent application PCT/AU2021/050287 and Australian patent AU 2020204336. These documents are incorporated herein by reference in their respective entireties.

Electrolysers, particularly alkaline electrolysers, are known to be more efficient when they are kept at temperature. However, current electrolysers must include heating and/or cooling systems to ensure that the electrolysers are operable at optimum temperatures. This adds complexity to the electrolysers and requires additional power to run the heating/cooling cycles, which in turn impacts the total cost of the resultant system which increases the cost of the produced hydrogen. There is a global drive to increase efficiencies in hydrogen generation to achieve a $2/kg target.

Integrating an electrolyser with a water purification/conditioning apparatus is not known in the art. Such water purification/conditioning apparatus remove impurities from the water supply, so it is suitable for feeding into the electrolyser. It will be appreciated this this, in turn, costs energy and efficiency, thereby increasing the unit cost of the resultant hydrogen. Such apparatus also has an ongoing maintenance cost in the form of filters and the like.

Ambient air contains a variable quantity of water vapor. Thus, the general atmosphere is a potential water source. Extracting this water from the surrounding atmosphere presents several technical challenges. Many attempts to extract water from atmospheric air have typically fallen short of the desirable criteria, including efficiency in the amount of water produced per amount of energy used, extracting the greatest possible percentage of the moisture available in the air under local conditions and producing acceptable quantities of water at all times of the day throughout the various weather, seasonal and climatic conditions. Accordingly, atmospheric water vapor is an essentially untapped source of an increasingly scarce commodity.

Refrigeration systems have been known for some time. Vapor-compression cycle refrigeration systems are most common today, but other types of refrigeration are possible including gas absorption and heat pumps. A refrigeration system may provide one or more closed-loop circuits for a refrigerant medium. If the refrigeration system uses a vapor-compression cycle, it may include a compressor, evaporator, expansion valve and condenser. For example, a compressor may compress a refrigerant from a saturated vapor state to a superheated vapor state. A condenser may then remove the superheated condition from the refrigerant vapor and then condense the refrigerant to a saturated liquid state.

Across an expansion valve, the refrigerant may become mixed states of liquid and vapor. Moreover, an evaporator may convert the refrigerant back to saturated vapor. During this cyclical process, an external surface of the evaporator will become cold. Some form or variation of this process may be used in refrigerators, freezers and air conditioning systems. Most refrigeration systems have some cooling element, through which air passes to shed heat and reach a lower temperature. In a vapor compression cycle refrigeration system, the cooling surface of the cooling element will be an exterior surface of the evaporator. An evaporator having a temperature of at most a dew point of air contacting the evaporator will cause liquid water to condense on an exterior surface of the evaporator.

Whenever the cooling element has a temperature at or less than the local dew point of the air, water vapor in the air will tend to condense into droplets of liquid water. When a cooling element has a temperature at or less than the freezing point of water, such as in a freezer, water vapor in the air will tend to condense and then freeze into ice.

In many residential and commercial refrigeration systems, this condensation is considered undesirable, and some refrigeration systems even have features for ameliorating such condensation. However, the principles causing condensation can be used to produce liquid water from water vapor in atmospheric air. Exemplary methods of water production and accompanying apparatus are described in U.S. Pat. No. 6,343,479, entitled “Potable Water Collection Apparatus” which issued on 5 Feb. 2002 and U.S. Pat. No. 7,121,101, entitled “Multipurpose Adiabatic Potable Water Production Apparatus and Method” which issued on 17 Oct. 2006.

These exemplary patented methods and devices present viable means of extracting liquid water from atmospheric air, including apparatus for transforming atmospheric water vapor into potable water and particularly for obtaining drinking-quality water through the formation of condensed water vapor on surfaces maintained at a temperature at or below the dew point for a given ambient condition. The surfaces upon which the water vapor is condensed are kept below the dew point by a refrigerant medium circulating through a closed fluid path, which includes refrigerant evaporation apparatus, thereby providing cooling of air flowing through the device and refrigerant condensing apparatus to complete the refrigeration cycle. It is desirable to increase efficiency of a water production system by increasing the efficiency of an associated refrigeration system and to provide efficient and economical water production during conditions when the ambient wet bulb and dry bulb temperatures indicate high relative humidity or less than ideal atmospheric conditions.

International Patent Publication WO 2010/039493 describes an apparatus for extracting water from air. A refrigeration system is defined by a closed-loop path for a refrigerant. The refrigeration system includes an evaporator and a sub-cooler. The evaporator is operable to cause liquid water to condense on an exterior surface of the evaporator. A water basin defines an inner volume and is positioned proximal to the evaporator for collecting water from the exterior surface of the evaporator.

The sub-cooler is positioned inside the inner volume of the water basin. Optionally, a mechanism is provided to maintain a selected water level in the water basin so that the sub-cooler remains submerged in water during operation. The sub-cooler may thus increase the operating efficiency of the water production system as compared with a system that does not use a water-cooled sub-cooler. The operating efficiency may be measured as either an amount of water condensed on the evaporator's exterior surface per time, or an amount of water condensed per unit input energy.

Other representative prior art includes U.S. Pat. No. 8,876,956, KR 20140122357 and US 2011/0232485.

It is well known that solar cells (e.g., photovoltaic cells) that produce electricity from solar energy suffer efficiency reduction above 25 degrees centigrade at a rate of approximately 0.5% per degree centigrade temperature rise. Therefore, above 25° C., the efficiency decreases as the temperature increases, which leads to a decrease in the total energy produced by a solar array, especially in areas that have the highest levels of direct normal irradiation. Such areas are typically hotter and naturally provide more opportunity for the solar cell to heat up over the course of the day as the solar irradiation increases.

Some systems, such as the Sunbooster system, utilise rainwater that is then poured down the face of the panels from a series of pipes arranged at the top portion of the solar cell when the temperature gets above a predetermined temperature, for example 25 degrees C. This cools the surface of the solar cell, which increases the efficiency of the cell as the ambient temperature and that of the cell increase.

Also known in the art is the use of greenery/plants grown under solar cells to increase the efficiency of the solar electricity generation. The shade of the solar cells stimulates the plants to grow toward the light, but the shade also protects the plants from the harsh sun. This leads to improved growth and less stress on the plants. The plants also create a microclimate under the solar cells by evaporating water, which also serves to cool the solar cells, thereby increasing the efficiency of electricity generation.

It is an object of the present invention to overcome or ameliorate one or more of the disadvantages of the prior art, or at least to provide a useful alternative.

It is an object of at least one preferred form of the present invention to provide a water capture and electrolysis system that by relatively efficient integration of the water capture and electrolysis modules, provides for relatively efficient conversion of the water to hydrogen.

It is important for electrolysers to maintain a voltage across the cell that generates the hydrogen, thereby to prevent a situation where the voltage drops to zero, leading to a reverse flow of electricity through the associated system or to a dangerous system state. Such a scenario leads to a serious risk relating to reversion of the electrolyser into a fuel cell (i.e. the electrolyser functions to convert hydrogen into electricity), particularly in alkaline-type electrolysers. Worsening the scenario, another likely result is introduction of gases in parts of an electrolyser subsystem which are not expected (or designed) to have gases. In that case, electricity is generated and can cause issues with computer controls and power systems (for instance as the are subjected to electricity in a format and amount that is unexpected). This can be potentially explosively catastrophic given the materials being generated and used in such a system—namely hydrogen.

Electrolysers can be configured to mitigate such problematic effects associated with removal of voltage, for instance by implementation of defined shutdown procedures. These procedures do, however, take time to implement.

In practice, this problem has not been given a great deal of consideration. This is because current systems in which renewable energy sources, such as, photovoltaic cells supply power to electrolysers include (and require) components for conversion from DC to AC in respect of power provided by the photovoltaic cells, and further components for conversion back from AC to DC thereby to provide input for the electrolyser. Such an approach is required on the basis that electrolysers require specific voltages and currents in order to maintain consistent production of hydrogen efficiently (and, although not by design, have an effect of inhibiting reversion as discussed above). A typical arrangement involves a photovoltaic cell capturing solar energy and producing energy in the form of electricity, with this electricity being fed into an inverter. The inverter passes the energy through one or more transformers, and then through a rectifier, with the rectifier being connected to the electrolyser.

The inclusion of components such as inverters, transformers, and rectifiers contributes significantly to the overall cost of such systems. For example, when considering hydrogen generation capital expenditure, such components can form up to 30% of the capital cost. Furthermore, such components lead to energy losses (for example through heat and conversion inefficiencies) during their respective conversion processes, which also means that an increased number of photovoltaic cells needs to be contemplated to allow for any potential losses.

Although the invention will be described with reference to specific examples it will be appreciated by those skilled in the art that the invention may be embodied in many other forms.

### Definitions

In describing and defining the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising” and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of” and “consisting essentially of”, where one of these three terms are used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The term “relative humidity” (RH) is the amount of water vapour present in air expressed as a percentage of the amount needed for saturation at the same temperature. Relative humidity may also be defined as the ratio of the partial pressure of water vapor to the equilibrium vapor pressure of water at a given temperature. Relative humidity depends on temperature and the pressure of the applicable system. The same amount of water vapor results in higher relative humidity in cool air than warm air. A related parameter is the dew point.

The terms “humid air” (description) and “incident air” (claims) are intended to be synonymous. It will be appreciated that for the purposes of the present invention, incident air (i.e., atmospheric air) is inherently humid, with varying degrees of relative humidity depending upon the location at which the incident air is taken from the atmosphere and fed to the method, apparatus and/or system of the invention.

The term “dew point” is the temperature to which air must be cooled to become saturated with water vapor. When further cooled, the airborne water vapour will condense to form liquid water (dew). When air cools to its dew point through contact with a surface that is colder than the air, water will condense on the surface. When the temperature is below the freezing point of water, the dew point is called the frost point, as frost is formed rather than dew. The measurement of the dew point is related to humidity. A higher dew point means there is more moisture in the air.

The term “solar array” (also known as concentrated solar power, concentrating solar power, concentrated solar thermal) means systems that generate solar power by using mirrors or lenses to concentrate a large area of sunlight onto a receiver. The energy may be used as thermal energy or may be used to generate electricity. Electricity is generated when the concentrated light is converted to heat (solar thermal energy), which drives a heat engine (usually a steam turbine) connected to an electrical power generator or powers a thermochemical reaction. An example of a solar array is a solar cell. Solar arrays may operate only when the sun shines or may run over 24-hour periods by the use of molten salts or storing thermal energy in thermal storage blocks, such as graphite or other material, so that the heat can be released over the periods when the sun is not shining. Solar arrays may be formed of concentric parabolic mirrors that follow the sun's path or may be mirrored troughs that focus the light to a central portion. As used in this specification, the term “solar array” also encompasses photovoltaic cells and CPV arrays for generating electricity from the sun.

The term “thermal energy” is intended to mean any source of energy related to heat. Non-limiting examples include geothermal energy, waste heat (for example from a power station, refinery, smelter, server farms, etc.) and other sources of heat. More specifically, “geothermal energy” is thermal energy generated and stored in the earth. Geothermal power is cost-effective, reliable, sustainable and environmentally-friendly, and has historically been linked to land areas on or near tectonic plate boundaries, for instance, California, New Zealand, Iceland and Japan.

The term “waste heat” means any thermal energy that may be discharged from a chemical or physical process, which is typically vented to the atmosphere. Waste heat occurs in almost all mechanical and thermal processes. Sources of waste heat include for example hot combustion gases discharged to the atmosphere, heated water released into environment, heated products exiting industrial processes, and heat transfer from hot equipment surfaces. The most significant amounts of waste heat are being lost in the industrial and energy generation processes, for example, in power generation, metallurgical processes, refining, compression of gasses, chemical processing, cooling, server farms, or in exhaust streams from any of the above.

The person skilled in the art would appreciate that the embodiments described above are exemplary only and that the electrical characteristics of the present application may be configured in a variety of alternative arrangements without departing from the spirit or the scope of the invention.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practised or carried out in various ways.

### SUMMARY OF THE INVENTION

Applicant has surprisingly developed a system wherein integration of a water maker with an electrolyser means that there is: water available for electrolysis; heat available to maintain the electrolyte at the requisite temperature(s); air cooling from the air outlets of the water maker to cool the electrolyser where overheating may be occurring; and water for cooling prior to being used for injection into the electrolyser. This means that any fluctuations experienced from the necessary shutdown/restart cycles of the electrolyser (solar powered, rather than grid connected) can be minimised, optionally with the aid of insulation to minimise nightly temperature drop, which in turn leads to a surprising increase in the efficiency of the hydrogen production in the region of about 3.9 to 4.4 kWh/Nm³, more preferably, about 4.23-4.25 kWh/Nm³ (47.0-47.2 kWh/kg) (conversion factor 11.126).

As will be understood by the skilled person, a 100% efficient electrolyser requires 39 kWh (3.51 kWh/Nm³) of electricity to produce 1 kg (0.09 Nm³) of hydrogen. Many electrolysers use approximately 4.7 kWh/Nm³ to generate hydrogen. This means that the present invention stands to increase the efficiency of hydrogen production by at least about 5, 6, 7, 8, 9, 10, 11, 12, 13, 14, 15, 16, 17, 18, 19 or 20%, more preferably, at least ˜9-10%. The present invention also reduces the cost of the electrolyser due to the omission of water purification/conditioning apparatus.

According to a first aspect of the present invention there is provided a method for enhancing the efficiency of hydrogen production from water by an electrolyser, the method comprising operatively associating an atmospheric water capture apparatus with the electrolyser such that: heat utilisation is relatively maximised; and current density is relatively minimised.

In an embodiment, the system is solar powered.

In an embodiment, the system is operable in daylight hours only.

In an embodiment, the water captured from the atmosphere and subsequently electrolysed does not require an intermediate purification step.

In an embodiment, the electrolyser is a PEM electrolyser or an alkaline electrolyser, preferably an alkaline electrolyser.

In an embodiment, the efficiency of hydrogen production is in the region of about 3.9 to 4.4 kWh/Nm³, more preferably, about 4.23-4.25 kWh/Nm³ (47.0-47.2 kWh/kg).

According to a second aspect of the present invention there is provided a hydrogen production system comprising an atmospheric water capture apparatus operatively associated with an electrolyser, wherein: a supply of water is available for electrolysis; a heat source is available to maintain electrolyte within the electrolyser at optimal temperatures; optionally, a source of cooling air from air outlets of the water capture apparatus to cool the electrolyser where overheating may be occurring; and a source of water is available for cooling prior to injection into the electrolyser.

In an embodiment, the fluctuations experienced from the necessary shutdown/restart cycles of the electrolyser are minimised.

In an embodiment, oxygen is produced as part of the electrolysis process as an oxygen by-product and retained for future use.

In an embodiment, the oxygen by-product is used to increase the efficiency of a wastewater treatment plant.

In an embodiment, the system further comprises a fuel cell to use the hydrogen to produce electricity and a water by-product.

In an embodiment, the fuel cell uses oxygen from the ambient air to generate electricity and a water by-product.

In an embodiment, the fuel cell uses the oxygen by-product to generate electricity and water by-product.

In an embodiment, the water by-product is mineralised to be suitable for human consumption.

In an embodiment, the water by-product is stored for later use in the electrolyser.

In an embodiment, the water by-product is injected into an underground aquifer.

In an embodiment, the water by-product is recycled back into the electrolyser.

In an embodiment, the system comprises insultation to maintain temperature overnight or during shut down periods, and/or to minimise heat loss overnight or during shut down periods.

In an embodiment, the efficiency of hydrogen production is in the region of about 3.9 to 4.4 kWh/Nm³, more preferably, about 4.23-4.25 kWh/Nm³ (47.0-47.2 kWh/kg).

In an embodiment, the efficiency of hydrogen production is increased by at least 5, 6, 7, 8, 9, 10, 11, 12, 13, 14, 15, 16, 17, 18, 19, or at least 20%, preferably at least 5, 10, 15, or 20%, preferably at least 7 to 13%.

In an embodiment of the first and/or second aspects, the step of collecting atmospheric water, comprises the steps of: a water absorption step, itself comprising: providing incident air to a reaction chamber, the air having an initial relative humidity, wherein the reaction chamber provided with at least one desiccant; associating the incident air with the desiccant, wherein the desiccant functions to lower the relative humidity of the incident air over a predetermined period, thereby providing dried air and spent desiccant; and exhausting the dried air to the atmosphere; a desiccant regeneration step, itself comprising: providing heating means at least partly communicable with the reaction chamber to provide heating thereto; and regenerating the spent desiccant by heating via the heating means to generate steam and regenerated desiccant; a steam condensation step, itself comprising: the steam being passed into a condenser, the condenser being communicable with the reaction chamber, and subsequently condensed to water; and harvesting the water.

In an embodiment of the first and/or second aspects, the dried air is exhausted to the atmosphere via the condenser.

In an embodiment of the first and/or second aspects, the incident air is provided to the reaction chamber via fanning or pumping means.

In an embodiment of the first and/or second aspects, the incident air is atmospheric air.

In an embodiment of the first and/or second aspects, the heating means derives thermal energy from renewable means selected from a solar array, a mirrored array or a solar thermal array. Preferably, the heating means derives thermal energy from a solar thermal array. In an embodiment of the first and/or second aspects, the heating means derives thermal energy from geothermal energy, waste heat (e.g., refinery, power station, smelter, server farms, etc., as defined above) or any other one or more source/s of heat.

In an embodiment of the first and/or second aspects, the heating means may also be used to circulate a cooling fluid for removing heat from the system. In an embodiment, the heating means uses a hot and cold oil circuit to heat or cool the system. In an embodiment, at least some of the excess heat drawn from the system by using the cooling fluid is recovered for use in the system.

In an embodiment of the first and/or second aspects, the system further comprises a cooling means to circulate a cooling fluid for removing heat from the system.

In an embodiment of the first and/or second aspects, the cooling means is in the form of a cooling jacket, at least partially surrounding each of the at least one reaction chamber or is at least partially formed integrally within the at least one reaction chamber.

In an embodiment of the first and/or second aspects, the cooling means is at least partially integrally formed with the reaction chamber and/or the desiccant.

In an embodiment of the first and/or second aspects, the cooling means is in the form of a cooling coil or is adapted to move a cooling medium through the desiccant.

In an embodiment of the first and/or second aspects, the system is operable only during sunlight hours and is not connected to any external power supply (it is “off grid”).

In an embodiment of the first and/or second aspects, the system is operable during day and night hours and is not connected to any external power supply (it is “off grid”). In an alternative, embodiment, the system is connected to an external power supply. In an alternative embodiment, the external power supply is one or more of a mains power supply, a battery, a fuel cell, a wind turbine, a tidal generator, a solar array, such as a solar cell (photovoltaic) or any energy source sufficient to enable 24-hour operation.

In an embodiment, the atmospheric water capture device produces water that is used for cooling the solar cell prior to injection into the electrolyser.

In an embodiment, the solar cell is cooled by the water or the water by-product.

In an embodiment, the solar cell is cooled by passing the water through a heat absorbing material in connection with the solar cell, thereby passing at least a portion of the heat to the water.

In an embodiment, the heat absorbing material is a pipe or tube made of a material that transports heat, such as metal or plastic.

In an embodiment, the solar cell includes a heat exchanger to remove heat from the solar cell into the water or water by-product.

In an embodiment, the heat exchanger is in fluid communication with the water or water by-product.

In an embodiment, the heat exchanger is adapted to move the heat from the solar cell to the water or water by-product.

In an embodiment, the efficiency of the solar cell is improved by at least 5%, preferably 6, 7, 8, 9, 10, 11, 12, 13, 14, 15, 16, 17, 18, 19, 20, 21, 22, 23, 24, or 25%.

In an embodiment, the atmospheric water capture device and/or the electrolyser are elevated from the ground, for example, by at least 1 metre, preferably 2, 3, 4, 5, or 6 metres.

In an embodiment, the atmospheric water capture device is elevated from the ground, for example, by at least 1 metre, preferably 2, 3, 4, 5, or 6 metres.

In an embodiment, the atmospheric water capture device and/or the electrolyser are elevated from the ground, for example, by at least 1 metre, preferably 2, 3, 4, 5, or 6 metres and the electrolyser is at ground level.

In an embodiment, the water and water by-product are stored in a vessel that is elevated from the ground, for example, by at least 1 metre, preferably 2, 3, 4, 5, or 6 metres.

In an embodiment, the water or water by-product is fed past the solar cells using gravity into a secondary water storage medium.

In an embodiment, the secondary water storage medium is used to feed water into the electrolyser.

In embodiment, the solar cell is cooled when a predetermined ambient temperature or surface temperature of the solar cell rises above 25 degrees centigrade.

As noted above, photovoltaic cells that produce electricity from solar energy suffer an efficiency reduction above 25 degrees centigrade at a rate of approximately 0.5% per degree Centigrade in temperature rise. Therefore, the efficiency decreases as the temperature increases, which leads to a decrease in the total energy produced by a solar array, especially in the areas that have the highest levels of direct normal irradiation. As also mentioned above, the use of greenery/plants under solar cells increase the efficiency of the solar electricity generation. The shade of the solar cells stimulates the growth of the plants to reach for the light, but the shade also protects the plants from the harsh sun. This leads to improved growth and less stress on the plants. The plants also create a microclimate under the solar cells by evaporating water, which cools the solar cells increasing the efficiency of electricity generation.

In an embodiment, the solar cell has one or more plants growing under it.

In an embodiment, the plants are edible plants such as fruits, herbs and spices, nuts, cacti, flowers, seeds, forageable plants, leaf vegetables and root vegetables.

In an embodiment, the plants are pastural plants, such as perennials and annuals, grasses and legumes, native and introduced grasses, C3 and C4 species and year-long greens.

In an embodiment, the plants are suitable for consumption by bovines, ovines or other farm animals.

In an embodiment, the water by-product is used to water the plants.

In an embodiment, the solar cell is cooled by the water or the water by-product and plants are grown under the solar cell. In an embodiment, the solar cell's efficiency is improved by at least 5%, preferably 6, 7, 8, 9, 10, 11, 12, 13, 14, 15, 16, 17, 18, 19, 20, 21, 22, 23, 24, or 25%.

In an embodiment, the solar cell is a PV or CPV array as defined above.

In an embodiment, the solar cell is a dual sided solar cell.

In an embodiment, the solar cell is a single axis tracking cell.

In an embodiment, the solar cell is a dual axis tracking cell.

In an embodiment of the first and/or second aspects, the system is operable overnight to load the desiccant using ambient air. In an embodiment, the incident air is passed over the desiccant overnight at low speed and/or volume. In an embodiment, the system uses batteries, fuel cells, or supercapacitors to provide electricity to run the at least one fan to load the desiccant.

In an embodiment of the first and/or second aspects, the reaction chamber is at least partly filled with the desiccant.

In an embodiment of the first and/or second aspects, the reaction chamber has at least one air inlet, for providing the incident air; and at least one air outlet, for exhausting the dried air and communicating the steam to the condenser.

In an embodiment of the first and/or second aspects, the method further comprises the step of actively cooling the heated regenerated desiccant by passing further incident air over the heated regenerated desiccant until it cools and/or becomes re-spent.

In an alternative embodiment, the method further comprises the step of actively cooling the heated regenerated desiccant by passing the dried air over the heated regenerated desiccant until it cools prior to commencing of a further cycle of the method.

In an embodiment of the first and/or second aspects, the method further comprises providing compression means to compress the incident air prior to providing it to the reaction chamber. It is understood by one of skill in the art that compressing air heats the air. Therefore, by sucking the air through the at least one fan, instead of blowing the air (i.e., compressing it), there may be increases in efficiencies, for example, at least 5% additional loading of water on the desiccant.

In an embodiment of the first and/or second aspects, the at least one fan is optionally in fluid connection with an intercooler. The intercooler, in use, removes excess heat that may be introduced into the system by compression or from the at least one fan. In an embodiment, the heat from the intercooler is recovered for use in the system, for example, the heating means.

In an embodiment of the first and/or second aspects, the at least one fan is a variable speed fan, which changes speed proportional to the relative humidity level of the humid air.

In an embodiment of the first and/or second aspects, the steam is purged by a stream of incident air and/or dried air.

In an embodiment of the first and/or second aspects, the at least one air inlet is a plurality of air inlets enable sufficient flow of the incident air into the reaction chamber.

In an embodiment of the first and/or second aspects, the at least one air outlet is a plurality of air outlets to enable sufficient flow of the dried air to the atmosphere and/or sufficient flow of the steam to the condenser.

In an embodiment of the first and/or second aspects, the at least one air inlet is attached to a distributer plate to diffuse the incident before or as it is provided to the reaction chamber.

In an embodiment of the first and/or second aspects, the reaction chamber is an enclosed cylinder with the at least one air inlet and the at least one air outlet located at opposite or distal ends of the cylinder.

In an embodiment of the first and/or second aspects, the heating means is in the form of a heating jacket or element, at least partially surrounding each of the at least one reaction chamber or is at least partially formed integrally within the at least one reaction chamber.

In an embodiment of the first and/or second aspects, the heating means is at least partially integrally formed with the reaction chamber and/or the desiccant.

In an embodiment of the first and/or second aspects, the heating means is in the form of a heating coil or element, or is adapted to move a heating medium such as superheated steam through the desiccant.

In an embodiment of the first and/or second aspects, the step of heating during the desiccant regeneration step is affected at an increasing rate of between about 1° C./min to about 100° C./min. In an embodiment, the step of heating during the desiccant regeneration step is affected at a rate sufficient to ensure the desiccant's integrity is maintained.

In an embodiment of the first and/or second aspects, the method is adapted for continuous or substantially continuous operation.

In an embodiment of the first and/or second aspects, the method has electricity-generating capacity at one or more of the water absorption step, the desiccant regeneration step or the steam condensation step.

According to a third aspect of the present invention there is provided an integrated atmospheric water capture and electrolysis apparatus wherein heat utilisation is relatively maximised; and current density is relatively minimised.

In an embodiment, the water captured from the atmosphere and subsequently electrolysed does not require an intermediate purification step.

In an embodiment, the electrolyser is a PEM electrolyser of an alkaline electrolyser, preferably and alkaline electrolyser.

In an embodiment, the efficiency of hydrogen production is in the region of about 3.9 to 4.4 kWh/Nm³, more preferably, about 4.23-4.25 kWh/Nm³ (47.0-47.2 kWh/kg).

According to a fourth aspect of the present invention there is provided a hydrogen production apparatus comprising an atmospheric water capture means operatively associated with an electrolyser, wherein: a supply of water is available for electrolysis; a heat source is available to maintain electrolyte within the electrolyser at optimal temperatures; optionally, a source of cooling air from air outlets of the water capture apparatus to cool the electrolyser where overheating may be occurring; and a source of water is available for cooling prior to injection into the electrolyser.

In an embodiment, fluctuations experienced from the necessary shutdown/restart cycles of the electrolyser are minimised.

In an embodiment, oxygen is produced as part of the electrolysis process as an oxygen by-product and retained for future use.

In an embodiment, the oxygen by-product is used to increase the efficiency of a wastewater treatment plant.

In an embodiment, the apparatus further comprises a fuel cell to use the hydrogen to produce electricity and a water by-product.

In an embodiment, the fuel cell uses oxygen from the ambient air to generate electricity and a water by-product.

In an embodiment, the fuel cell uses the oxygen by-product to generate electricity and water by-product.

In an embodiment, the water by-product is mineralised to be suitable for human consumption.

In an embodiment, the water by-product is stored for later use in the electrolyser.

In an embodiment, the water by-product is injected into an underground aquifer.

In an embodiment, the water by-product is recycled back into the electrolyser.

In an embodiment, the system comprises insultation to maintain temperature overnight or during shut down periods, and/or to minimise heat loss overnight or during shut down periods.

In an embodiment, the efficiency of hydrogen production is in the region of about 3.9 to 4.4 kWh/Nm³, more preferably, about 4.23-4.25 kWh/Nm³ (47.0-47.2 kWh/kg).

In an embodiment of the third or fourth aspects, the atmospheric water capture means comprises: means for effecting a water absorption step, itself comprising: providing incident air to a reaction chamber, the air having an initial relative humidity, wherein the reaction chamber provided with at least one desiccant; associating the incident air with the desiccant, wherein the desiccant functions to lower the relative humidity of the incident air over a predetermined period, thereby providing dried air and spent desiccant; and exhausting the dried air to the atmosphere; means for effecting a desiccant regeneration step, itself comprising: providing heating means at least partly communicable with the reaction chamber to provide heating thereto; and regenerating the spent desiccant by heating via the heating means to generate steam and regenerated desiccant; means for effecting a steam condensation step, itself comprising: the steam being passed into a condenser, the condenser being communicable with the reaction chamber, and subsequently condensed to water; and harvesting the water.

In an embodiment of the third or fourth aspects, the apparatus further comprises means for exhausting the dried air the atmosphere via the condenser.

In an embodiment, the means for exhausting the dried air is used for cooling or maintaining the temperature of the electrolyser.

In an embodiment of the third or fourth aspects, the incident air is provided to the reaction chamber via fanning or pumping means.

In an embodiment of the third or fourth aspects, the incident air is atmospheric air.

In an embodiment of the third or fourth aspects, the heating means derives thermal energy from renewable means selected from a solar array, a mirrored array or a solar thermal array. Preferably, the heating means derives thermal energy from a solar thermal array. In another embodiment, the heating means derives thermal energy from geothermal energy, waste heat (e.g., refinery, power station, smelter, server farms, etc.) or any other one or more source/s of heat.

In an embodiment, the heating means is used to minimise temperature fluctuations in the electrolyte of the electrolyser.

In an embodiment, the heating means is formed integrally with or at least partially surrounds the electrolyte housing.

In an embodiment of the third or fourth aspects, the solar thermal energy is stored in a thermal energy storage unit, which may be underground.

In an embodiment, the thermal energy storage unit regulates the temperature of the electrolyte overnight.

In an embodiment of the third or fourth aspects, the reaction chamber is at least partly filled with the desiccant.

In an embodiment of the third or fourth aspects, the reaction chamber has at least one air inlet, for providing the incident air; and at least one air outlet, for exhausting the dried air and communicating the steam to the condenser.

In an embodiment of the third or fourth aspects, the apparatus further comprises means for conducting the step of actively cooling the heated regenerated desiccant by passing further incident air over the heated regenerated desiccant until it cools and/or becomes re-spent.

In an alternative embodiment, the apparatus further comprises means for conducting the step of actively cooling the heated regenerated desiccant by passing the dried air over the heated regenerated desiccant until it cools prior to commencing of a further cycle of the method.

In an embodiment of the third or fourth aspects, the apparatus further comprises compression means to compress the incident air prior to providing it to the reaction chamber.

In an embodiment of the third or fourth aspects, the steam is purged by a stream of incident air and/or dried air.

In an embodiment of the third or fourth aspects, the at least one air inlet is a plurality of air inlets enable sufficient flow of the incident air into the reaction chamber.

In an embodiment of the third or fourth aspects, the at least one air outlet is a plurality of air outlets to enable sufficient flow of the dried air to the atmosphere and/or sufficient flow of the steam to the condenser.

In an embodiment of the third or fourth aspects, the at least one air inlet is attached to a distributer plate to diffuse the incident before or as it is provided to the reaction chamber.

In an embodiment of the third or fourth aspects, the reaction chamber is an enclosed cylinder with the at least one air inlet and the at least one air outlet located at opposite or distal ends of the cylinder.

In an embodiment of the third or fourth aspects, the heating means is in the form of a heating jacket or element, at least partially surrounding each of the at least one reaction chamber, or is at least partially formed integrally within the at least one reaction chamber.

In an embodiment of the third or fourth aspects, the heating means is at least partially integrally formed with the reaction chamber and/or the desiccant.

In an embodiment of the third or fourth aspects, the heating means is in the form of a heating coil or element or is adapted to move a heating medium such as superheated steam through the desiccant.

In an embodiment of the third or fourth aspects, the step of heating during the desiccant regeneration step is affected at an increasing rate of between about 1° C./min to about 100° C./min.

In an embodiment of the third or fourth aspects, the apparatus is adapted for continuous or substantially continuous operation.

In an embodiment of the third or fourth aspects, the apparatus has electricity-generating capacity at one or more of the water absorption step, the desiccant regeneration step or the steam condensation step.

In an embodiment of the third or fourth aspects, oxygen is produced as part of the electrolysis process as an oxygen by-product and retained for future use.

In an embodiment of the third or fourth aspects, the oxygen by-product is used to increase the efficiency of a wastewater treatment plant.

In an embodiment of the third or fourth aspects, the system further comprises a fuel cell to use the hydrogen to produce electricity and a water by-product.

In an embodiment of the third or fourth aspects, the fuel cell uses oxygen from the ambient air to generate electricity and a water by-product.

In an embodiment of the third or fourth aspects, the fuel cell uses the oxygen by-product to generate electricity and water by-product.

In an embodiment of the third or fourth aspects, the water by-product is mineralised to be suitable for human consumption.

In an embodiment of the third or fourth aspects, the water by-product is stored for later use in the electrolyser.

In an embodiment of the third or fourth aspects, the water by-product is injected into an underground aquifer.

In an embodiment of the third or fourth aspects, the water by-product is recycled back into the electrolyser.

In an embodiment of the third or fourth aspects, the system comprises insultation to maintain temperature overnight or during shut down periods, and/or to minimise heat loss overnight or during shut down periods.

In an embodiment of the third or fourth aspects, the efficiency of hydrogen production is in the region of about 3.9 to 4.4 kWh/Nm³, more preferably, about 4.23-4.25 kWh/Nm³ (47.0-47.2 kWh/kg).

In an embodiment of the third or fourth aspects, the efficiency of hydrogen production is increased by at least 5, 6, 7, 8, 9, 10, 11, 12, 13, 14, 15, 16, 17, 18, 19, or at least 20%, preferably at least 5, 10, 15, or 20%, preferably at least 7 to 13%.

According to a fifth aspect of the present invention there is provided a system for collecting atmospheric water, the system comprising operatively associating a plurality of apparatus as defined according to the third or fourth aspects of the present invention.

In an embodiment, the plurality of water collection apparatus is associated in series or in parallel.

Preferred embodiments of the method, apparatus and system aspect are now described interchangeably. That is, one skilled in the art will appreciate that the features described can be applied to each of the method, apparatus or system aspects of the invention.

In a preferred embodiment, the at least one fan comprises a filter, screen or baffle. In preferred embodiments, the at least one fan may suck or blow the air through the system. In one embodiment, the at least one fan sucks air through the system. In one embodiment, the at least one fan blows air through the system.

In an embodiment, the at least one fan is a variable speed fan, which changes speed proportional to the relative humidity level of the humid air. For example, faster speeds and/or greater air flow may be more advantageous to operate in areas with low relative humidity, where the water content in each cubic metre of air is low. Conversely, slower speeds and/or lower air flow may be more advantageous to operate in areas with low relative humidity, where the water content in each cubic metre of air is high.

One embodiment provides a method for configuring an electrolyser-based hydrogen generation system, wherein the system includes an electrolyser subsystem across which an input voltage is supplied by a power source, thereby to inhibit reversion of one or more electrolyser components within the electrolyser subsystem to fuel cell operation, the method including:

configuring a connection between the power source and the electrolyser subsystem such that: (i) there is no conversion between DC and AC power; and (ii) reverse current flow from the one or more electrolyser components within the electrolyser subsystem is inhibited in the event that the input voltage is reduced or removed.

One embodiment provides a method for optimising operation of an electrolyser-based hydrogen generation system, wherein the system includes an electrolyser subsystem to which power is supplied by a renewable power source, wherein the electrolyser subsystem includes a plurality of discrete electrolyser components, the method including:
maintaining data representative of capacity of each of the plurality of discrete electrolyser components;
receiving input representative of predicted future power output of the renewable power source, wherein the predicted future power output is determined based on processing of real-time weather monitoring and/or forecasting data;
based on the predicted future power output for a defined time, executing an algorithm thereby to select a subset of the plurality of discrete electrolyser components, thereby to match electrolyser capacity within a threshold range of predicted future power output; and
controlling start-up and/or shut-down procedures amongst the plurality of discrete electrolyser components, thereby to configure the system such that the subset of the plurality of discrete electrolyser components are operational at the defined time.

One embodiment provides a method for optimising operation of an electrolyser-based hydrogen generation system, wherein the system includes an electrolyser subsystem across which an input voltage is supplied by a solar power source, wherein the electrolyser subsystem includes a plurality of discrete electrolyser components, the method including:

operating a computer controller to manage connection/disconnection of each of the plurality of discrete electrolyser components on an individual basis, thereby to optimise operation of the electrolyser subsystem based on measured and/or predicted input voltage supplied by the solar power source.

Embodiments also include systems configured based on the methods disclosed above, and/or configured to perform methods disclosed above.

### BRIEF DESCRIPTION OF THE DRAWINGS

Certain preferred embodiments of the invention will now be described, by way of example only, with reference to the accompanying drawings in which:

FIG. 1 is a chart depicting a relatively simple form of the invention, as described herein.

FIG. 2 is a chart representing a form of the invention having accompanying electrolysis and fuel cell capacity.

FIG. 3 shows a proposed arrangement of adsorption sections in an adsorption tower, in accordance with a preferred embodiment of the invention. For example, it may be advantageous to run the adsorption sections in parallel during the adsorption cycle in order to achieve a high feed flow rate of air, whilst keeping the pressure drop below a preferred pressure and/or run the adsorption sections in series during the desorption cycle, in order to enable high desorption air flow rates which enable high heat transfer, whilst not reducing the water vapour concentration considerably in the condenser feed gas.

FIG. 4 shows a conceptual 3D model of a pilot plant corresponding to a preferred embodiment of the invention. Heating each of the discrete separate compartments sequentially is particularly preferred when the reaction chamber is a vertical reaction chamber, for example, when the discrete separate compartments are arranged substantially above one another. It will be appreciated that sequential heating from the bottom upwards serves to at least partially pre-heat at least one chamber above that receiving direct heating. This may result in substantial power savings.

FIG. 5 shows correlated absolute humidity data from the outlet of the adsorbent tower. Comparing the average ambient humidity throughout the adsorption phase, and the outlet absolute humidity. The difference in which can be determined to be the differential loading of the adsorbent/removal of humidity from the inlet air stream.

FIG. 6 depicts average adsorbent loading graph of an adsorption section taken from the arrangement described above.

FIG. 7 shows correlated adsorbent loading, with the assumed air flowrate of 480 Nm3/h, inlet absolute humidity of 20.7 g/m³ dry air, and 75 kg of silica gel; derived from outlet humidity data. Data shifted by 0.0479 kg/kg to allow comparison between simulation and measured data.

FIG. 8 shows cumulative water adsorbed from the inlet air stream, with the assumed air flowrate of 480 Nm³/h, inlet absolute humidity of 20.7 g/m³ dry air; derived from outlet humidity data.

FIG. 9 represents extended desorption cycle of the column after determining the new valves were leak free. Purge air flow of 100 L/min. Heater set to 9 kW and an oil set-point of 180° C. Purge stream initiated at start of oil heating cycle. Collected water of approximately 3.1 kg.

FIG. 10 shows adsorption cycle graph of cycle “2021.02.13”. Starting column internal temperature of 175° C., final internal temperature of 77° C. Average feed flow of ˜465 Nm³/h of ambient air. Expected water adsorbed over the cycle of ˜1.9 kg, with an average adsorption of 3.57 g/m³ of feed air. Out of range data disregarded.

FIG. 11 relates to average adsorbent loading graph of the column-adsorption cycle of 2021.02.13, shifted up by 0.479 kg/kg for comparison to the modelling data.

FIG. 12 depicts first adsorption cycle of cycle “2021.02.14”. Starting column internal temperature of ˜44° C., average column temperature of ˜56.5° C. Average feed flow of ˜460 Nm³/h of ambient air. Estimated loading of 120 g of water due to the presence of a negative difference between the inlet and outlet humidity. Assuming erroneous results caused by condensation present in the outlet manifold. Disregarding the negative results, results in an expected water adsorption of ˜690 g with an average adsorption of 1.2 g/m³ of feed air.

FIG. 13 shows desorption cycle with the heater set to 18 kW, purge air started once internal column temperature reached 100° C. Purge stream flow rate of 100 LPM. Collected water of approximately 2 kg, which is approximately a 66-81% recovery of the expected adsorbed water present from the two adsorption cycles performed.

FIG. 14 relates to temperature Profiles of desorption cycle 2021.02.14. T1-T4 represent the internal column temperatures within Zones 1-4 starting from the bottom of the column.

FIG. 15 demonstrates a second adsorption cycle of 2021.02.14. Starting column internal temperature of ˜165° C., final column temperature of ˜100° C. Average feed flow of ˜460 Nm³/h of ambient air. Expected water adsorbed over the cycle of ˜2.1 kg, with an average adsorption of 4.04 g/m³ of feed air. Out of range data disregarded. The disruption to the data at approximately 500 seconds was the throttling of inlet valves to increase the mass transfer time of the air within the column.

FIG. 16 shows the average adsorbent loading graph of the column-second adsorption cycle of 2021.02.14, shifted up by 0.479 kg/kg for comparison to the modelling data.

FIG. 17 illustrates a block flow diagram of the WPA and its auxiliary systems. In the block flow diagram, adsorption bank 1 and 2 are in its adsorption cycle, whilst adsorption bank 3 is in its desorption cycle.

FIG. 18 compares the seasonal variations of water content at the test site (Tennant Creek, Northern Territory, Australia) for the period of 1969 to 2010. The mean absolute water content assumed for the simulation of the WPU (6.47 g/kg dry air) is also shown.

FIG. 19 shows the proposed arrangement of adsorption sections in an adsorption tower.

FIG. 20 shows the Aspen Adsorption simulation flowsheet of Water Production Assembly.

FIG. 21 illustrates the average adsorbent loading for a single adsorption section, based on the simulation results from Aspen Adsorption. It can be seen that adsorption of water from the air onto the silica gel occurs during the initial 4000 seconds, followed by desorption of the water during the next 2000 seconds.

FIG. 22 illustrates the average adsorbent temperature for a single adsorption section, based on the simulation results from Aspen Adsorption. Comparing FIG. 21 and FIG. 22, it can be seen that the increase of adsorbent temperature (due to the hot oil) causes the desorption of the water from the adsorbent. As expected, the detailed results from Aspen Adsorption indicate that there are adsorbent loading gradients and temperature gradients across each adsorption section. These gradients are not shown in FIG. 21 or FIG. 22.

FIG. 23 illustrates the condenser feed gas concentration for four adsorption sections, based on the simulation results from Aspen Adsorption. As shown in the associated table, the condensing temperature was specified as 65° C. Air saturated with water at 65° C. has a concentration of ˜0.25 kmol H₂O per kmol. As the condenser feed gas concentration is much larger than 0.25 kmol H₂O per kmol, a large amount of water will condense in the condenser.

FIG. 24 shows a water balance based on the simulation results. The mass of water recovered is approximately 43% of the water in the air fed to the water production assembly.

FIG. 25 shows the schematic set up of the alkaline water electrolyser.

FIG. 26 shows the simulation model associated with the alkaline electrolyser.

FIG. 27 depicts the results of Run A. The data show that temperature increases during operation due to electrolysis energy loss and decreases during shutdown.

FIG. 28 shows the results of Run B. The data show that if heat is utilised to raise the electrolyte temperature, relatively high efficiency operation can be achieved.

FIG. 29 shows the results of Run C. The data show that the speed of temperature decrease during shutdown slows significantly.

FIG. 30 illustrates a prior art hydrogen generation system.

FIG. 31A to FIG. 31F illustrate hydrogen generation systems according to various embodiments.

FIG. 32 diagrammatically represents cascading operation of electrolyser cells.

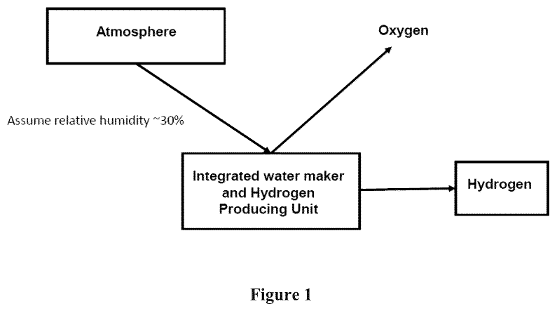

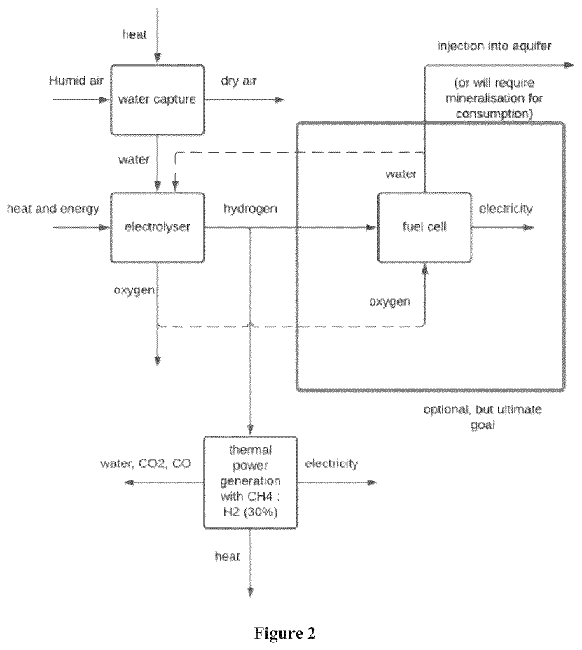

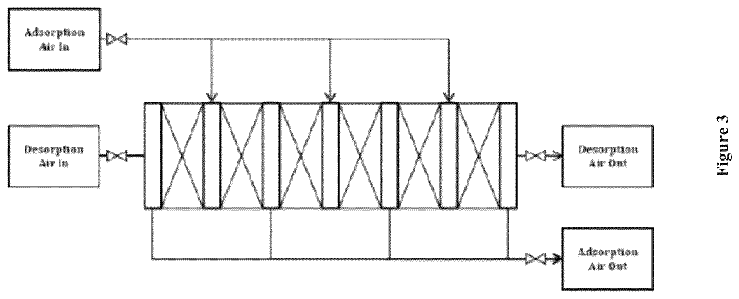

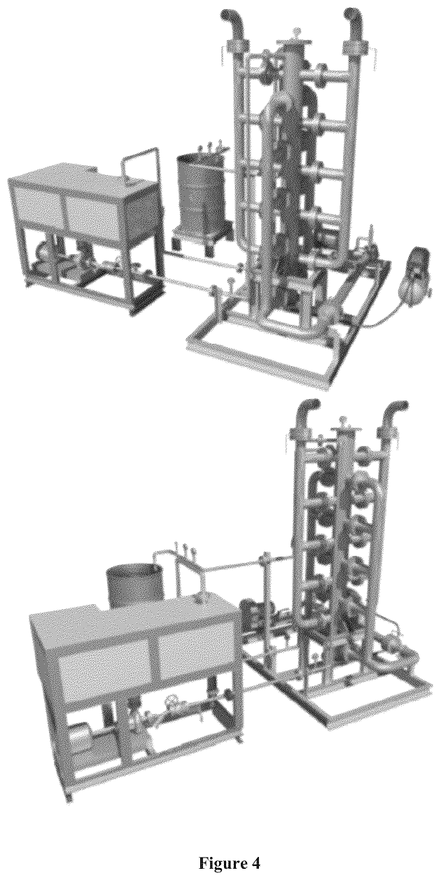

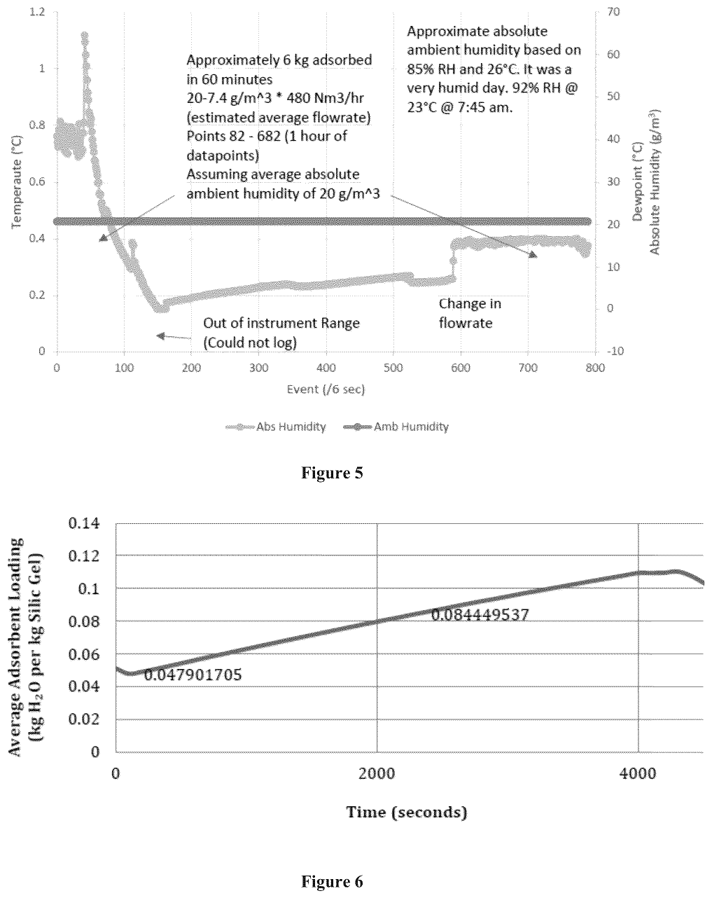

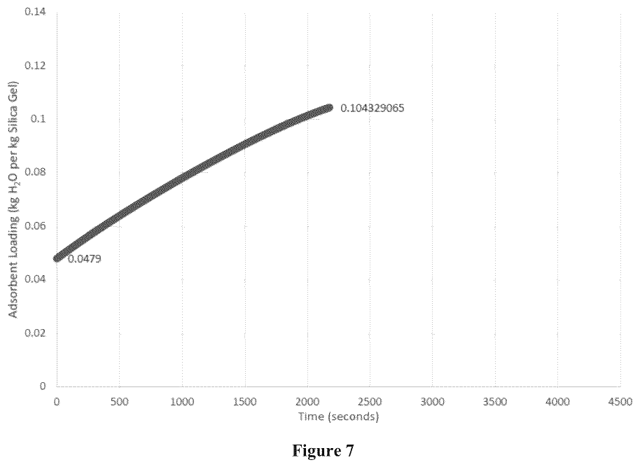

### DETAILED DESCRIPTION OF THE INVENTION

The skilled addressee will understand that the invention comprises the embodiments and features described herein, as well as all combinations and/or permutations of the disclosed embodiments and features.

The present invention relates to the integration of a water making unit (such as that described in PCT/AU2021/050287 or Australian patent AU 2020204336) with an alkaline or PEM electrolyser to facilitate relatively efficient hydrogen production. There is a global drive to increase efficiencies in hydrogen generation to achieve a $2/kg target.

Applicant has surprisingly developed a system wherein integration of a water maker with an electrolyser means that there is: water available for electrolysis; heat available to maintain the electrolyte at the requisite temperatures; air cooling from the air outlets of the water maker to cool the electrolyser where overheating may be occurring; and water for cooling prior to being used for injection into the electrolyser.

This means that the fluctuations experienced from the necessary shutdown/restart cycles of the electrolyser (solar powered) can be minimised, which in turn leads to a surprising increase in the efficiency of the hydrogen production in the region of about 3.9 to 4.4 kWh/Nm³, more preferably, about 4.23-4.25 kWh/Nm³ (47.0-47.2 kWh/kg) (conversion factor 11.126). It will be appreciated that a 100% efficient electrolyser requires 39 kWh of electricity to produce 1 kg (0.09 Nm³) of hydrogen. Many electrolysers are approximately 4.7 kWh/Nm³. This means that the present invention stands to increase the efficiency of hydrogen production by at least 5, 6, 7, 8, 9, 10, 11, 12, 13, 14, 15, 16, 17, 18, 19, or at least 20%, preferably at least 5, 10, 15, or 20%, preferably at least 7 to 13%, most preferably, at least ˜9-10%.

The key to a water from air process is the absorption and desorption profiles of the desiccant. The empirical data will be compared to, and used to refine, the process simulation for the parallel temperature swing adsorption units.

During testing, it was determined that there is an inherent thermal lag to the system induced by the heat up and cool down time of the hot oil circuit that, in its current iteration, prevents a rapid heating and cooling of the desiccant bed.

In the initial testing, the approximate absolute ambient humidity has been used and was determined as the average over the run conditions of 85% RH at 26° C., representing approximately 20.7 g/m³ dry air or (16.9 g/kg dry air). The inlet flowmeter had not yet been installed, but it can be assumed to equal the reading of 480 Nm³/h read from the flowmeter after the commissioning run. The initial commissioning run involved a 3 hour 20 minute desorb cycle of the column to ensure the majority of the moisture in the desiccant column was desorbed. The heating of the bed was achieved through stepwise increase of the hot oil heater's temperature set point from 140° C. through to the maximum advised silica desorption temperature of 180° C. During the desorption cycle, a constant air purge stream of 100 L per minute was maintained.

Once the internal bed temperature was measured to be in excess of 140° C., there was evidence of leakage of steam through the blast gates attached to the column. This was visible due to the vapour condensing mid-air and condensation leaking through the gates. The leakages of the water vapour were not uniform throughout the manifolds, evidenced through temperature and pressure differentials between each of the nozzles. Despite the leaking water vapour, the discharge line from the top of the column retained some flow. This was evident in the discharge thermometer showing the temperature of the line to be approximately 140° C. during the desorb cycle. The condenser proved to be adequate as the outlet temperature of the condenser remained below 24° C. throughout the cycle. The resulting condensation within the condenser culminated in approximately 1.8 kg of water.

After the silica had been desorbed, the blast gates were opened and the inlet blower started, whilst the hot oil heater was still circulating hot oil. The temperature set point was set to 0° C. and the heater turned off, but the oil circulation pump remaining on to reduce the temperature of the hot oil. Once the blower had been started, residual condensation in the manifolds and wider system were ejected from the air outlet; after approximately 4 minutes all residual water in the system was removed by the air flowing.

The outlet air temperature spiked after this, with the outlet humidity meter showing a rapid decline in absolute humidity in the outlet air. This is thought to be the synergy of the cooling of the bed and the subsequent increase of adsorption capacity of the silica, and the heat exchange of the air. The outlet humidity of the system reached near zero, indicating perfect adsorption of the inlet water; it should be noted that this is likely due to the inherent error of the relative humidity probes at low humidity and higher temperatures. For the comparison between simulation data and measured data a period of approximately 2175 seconds of uninterrupted, smooth data was chosen as a representative sample.

Using the difference between baseline of the inlet ambient humidity and the outlet absolute humidity the differential adsorbent loading rate was calculated across this timeframe, using the assumed 480 Nm³/h inlet air flowrate. This was integrated to give the cumulative water adsorbed by the silica, before dividing by the total desiccant weight of 75 kg to give the adsorbent loading in kg water per kg silica. To allow for the comparison between this loading curve and the simulated curve the curve has been offset by 0.0479 kg/kg.

Comparing the measured and simulated data over a similar time frame of approximately 2,200 seconds, the measured adsorbent loading is ˜0.02 kg/kg higher than what was simulated. This is approximately 23.5% higher adsorbent loading in the same timeframe. This can be explained through the much higher absolute ambient humidity that was present on the testing day compared to the 4.49 g/kg dry air (Relative humidity of 21.9% at 27.5° C.) used for the simulation. In addition, the silica gel is of different radius and bulk density to the simulation inputs, with particle size of 3-5 mm and bulk density of 750 kg/m³.

Three adsorption cycles were completed and two full desorption cycles. The first desorption cycle of the column was conducted after determining that the outlet and inlet humidity were near equal; possibly indicating the column was at equilibrium. An extended desorption cycle was conducted to profile the desorption of water from the column from a cold start.

A pilot plant was simulated to produce an estimated ˜17 L/day of water per a 10-hour day over 6 full adsorption/desorption cycles throughout the day, with an adsorption cycle of ˜4000 seconds and desorption cycle of ˜2000 seconds. In commissioning of the pilot plant, it was found that per 4,000 second adsorption cycle (at higher than simulated bed temperatures) the column adsorbed approximately 2 kg of water with the desorption cycle taking approximately 5,000 seconds and condense 2 kg of water. The discrepancy in the desorption cycle timing is due to the temperature lag of the system and time taken to heat and cool the oil. Detailed discussion of each of the commissioning adsorption and desorption runs are described below.

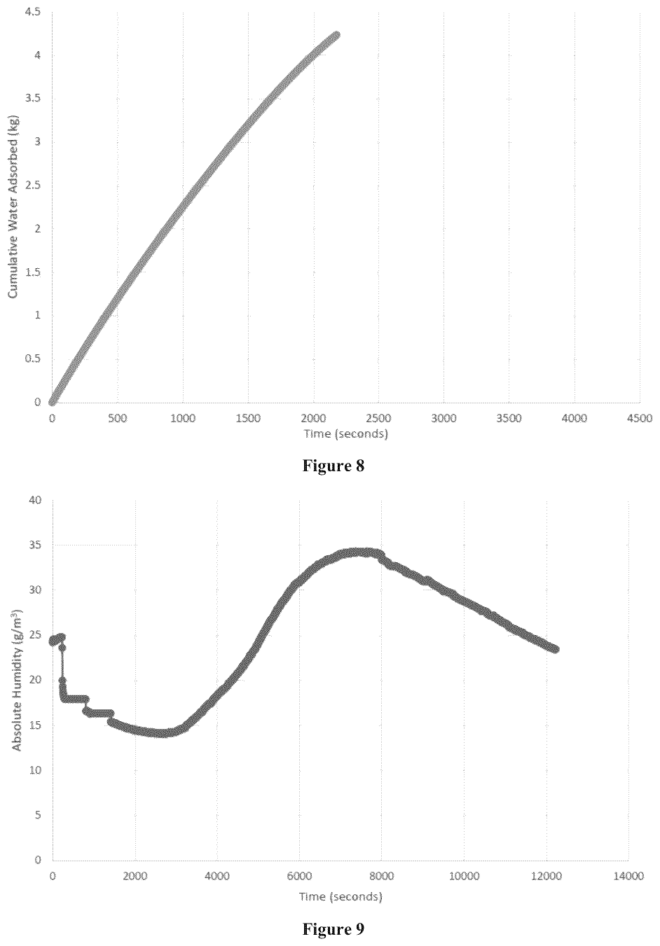

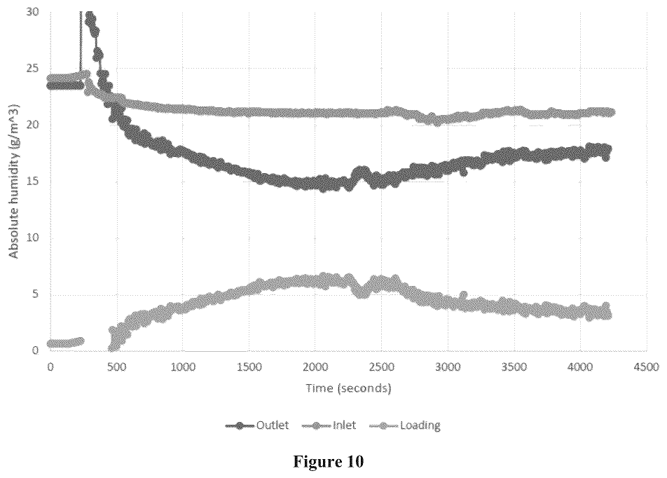

The extended desorption cycle was to profile the desorption of the water from the silica from what was an expected equilibrium state. With reference to FIG. 9, at approximately 8,000 seconds the profile of the graph changes to linear; it is hypothesised that this is due to the silica being fully desorbed of any water. This is supported by the temperature of the column reaching near isothermal and the discharge temperature indicator showing a decline in temperature, denoting the absence of water in the stream.

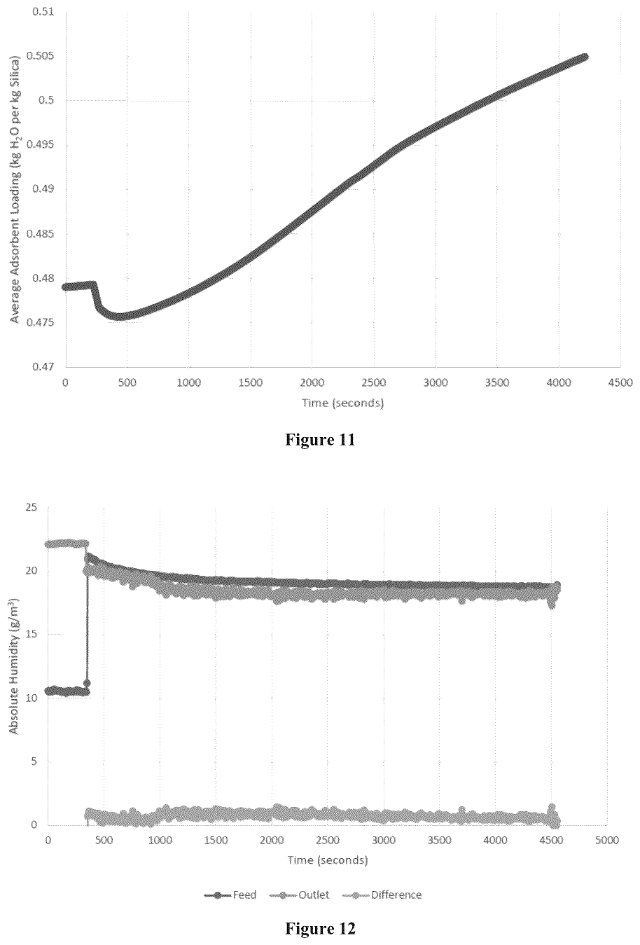

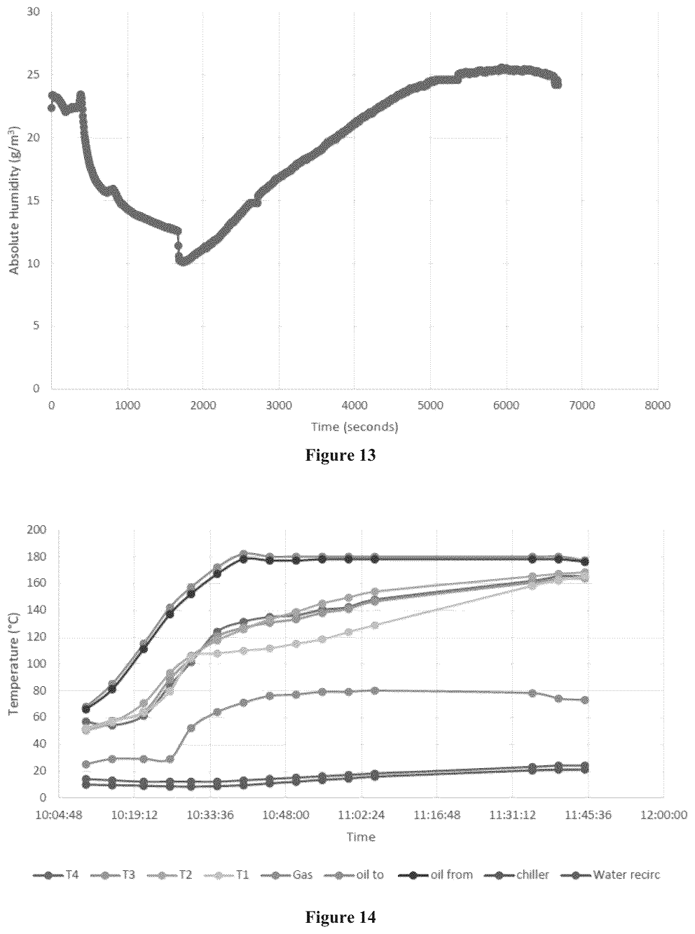

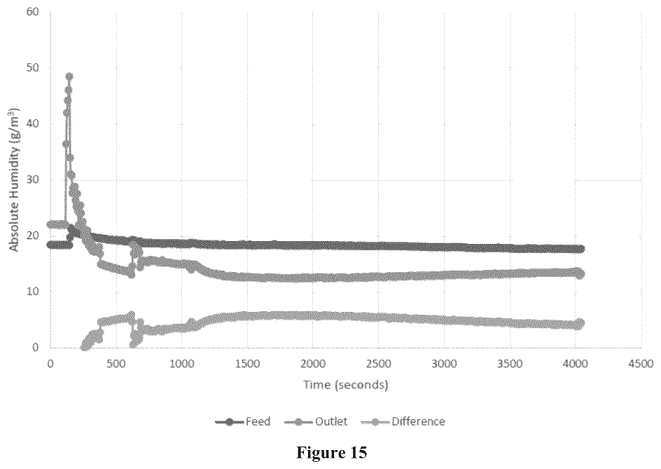

After the extended desorb cycle, a full adsorb cycle was run. The spike in the outlet humidity is likely due to the expulsion of any condensed water in the plenums upstream of the outlet manifold valves. The loading was taken to be the average difference in the inlet and outlet humidity across the range, discounting the short time frame of high outlet humidity. At the culmination of the adsorb cycle, the column was isolated to atmosphere. The internal column temperature at the start of the adsorption cycle was ˜175° C., cooling to ˜77° C. across the duration. It was estimated that 2.1 kg of water was adsorbed during the cycle with an average adsorption of 3.57 g/m³ of incipient feed air. This represents an estimated increase in adsorbent loading of 0.026 kg/kg, as shown in FIG. 11, compared to ˜0.06 estimated in the model at a bed temperature of ˜40° C.

Another adsorption cycle was performed after letting the column cool overnight. The intention was to see the cold adsorption characteristics of the silica. From the data it appears that the silica may have been nearly saturated with water, as the difference between the inlet and outlet humidity was minimal across the cycle.

It was hypothesised that a majority of the water being desorbed was not condensing due to the small temperature difference. A different operating mode of the oil heat up and desorption process was conducted. With the oil preheating the bed with no purge air stream until the internal column temperature reached 100° C., and the heater set to a higher heat output to minimise the time spent at lower temperature differences.

The second adsorption cycle proved to be the most consistent. This run was to test the efficiency gained by manipulating the flow pattern through the column to effectively increase the mass transfer time. This was achieved by closing all but the Zone 5 (top zone) outlet manifold valve, and by throttling the same zone's inlet valve. The throttling of the inlet valve was done without restricting the overall flow through the system noticeably as per the flow indicator.

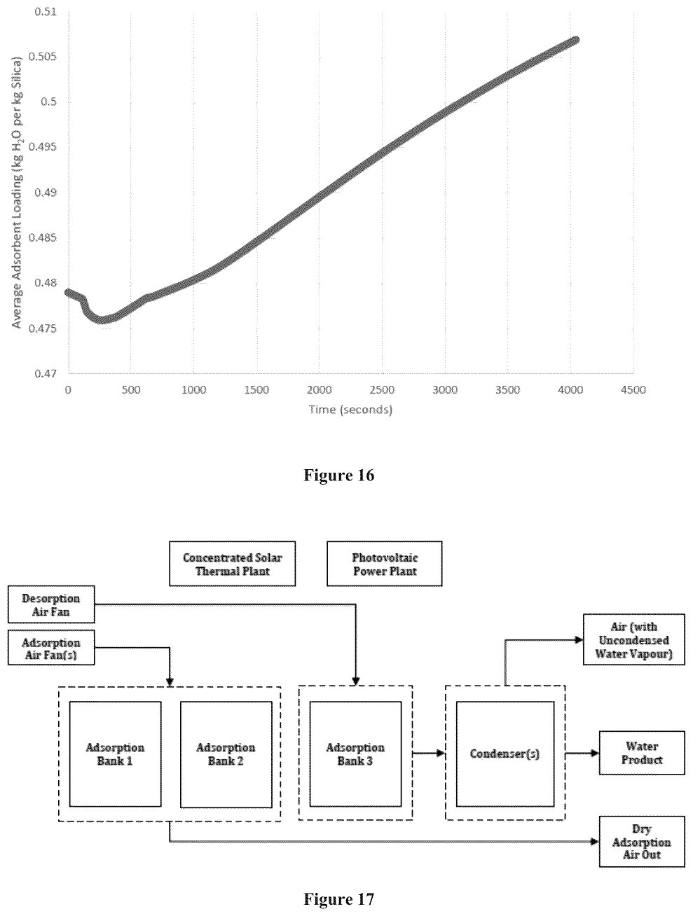

The position of the valve has been marked for future use; as closing it any further results in the bed fluidising, which was audible even over the inlet blower. The internal column temperature at the start of the adsorption cycle was ˜165° C., cooling to ˜100° C. across the duration. It was estimated that 2.1 kg of water was adsorbed during the cycle with an average adsorption of 4.04 g/m³ of incipient feed air. This represents an estimated increase in adsorbent loading of 0.028 kg/kg, as shown in FIG. 16, compared to ˜0.06 estimated in the model at a bed temperature of ˜40° C.

The water production unit (WPU) consists of several water production assemblies (WPA) that contain a desiccant such as silica gel; a desiccant is a hygroscopic medium that has the ability to adsorb water from humid air. The WPA will apply temperature swing adsorption to exploit the decrease in water adsorption capacity of silica gel at increased temperatures in order to recover the adsorbed water.

In the proposed process, atmospheric air will be sent to the WPAs whereby the water in the air will adsorb onto the silica gel. Next, the silica gel in the WPAs will be heated, resulting in the desorption of some of the water as water vapour. The desorbed water vapour will then be condensed as the water product in condensers.

The WPU consists of multiple WPAs, comprising: fans (to send humid air to the adsorption towers during the adsorption cycle; and to aid in the desorption of the water from the adsorption towers during the desorption cycle) adsorption towers (to house the silica gel upon which the adsorption and desorption of water occurs) and condensers (to condense the water vapour during the desorption cycle).

With regards to the auxiliary systems, the WPU would require: power supply (photovoltaic power plant to power the fans and pumps); and a heat supply (concentrated solar thermal plant to provide heat for the desorption).

FIG. 17 illustrates a block flow diagram of the WPA and its auxiliary systems. In the block flow diagram, adsorption bank 1 and 2 are in its adsorption cycle, whilst adsorption bank 3 is in its desorption cycle.

TABLE 1
Main process assumptions - Water Production Unit (WPU)

| | |
|---|---|
| Plant size | 2.5 kL per day water production capacity |
| | (day = 10 hours) |
| Ambient air (mean) | Temperature = 27.5° C.; Site pressure = |
| | 100.5 kPa; Absolute water content = 6.47 |
| | g/kg dry air (Relative humidity = 29.5% |
| | @ 27.5° C.) |
| Adsorption air feed fan(s) | Fan supply pressure = 4 kPa · g |
| Adsorption towers (TSA) | Process employed is Temperature Swing |
| | Adsorption; 10 hour/day operation; |
| | Desiccant medium = Silica gel, type A |
| Condenser(s) | Indirect air cooling; Condensing |
| | temperature = 65° C. |
| Photovoltaic power plant | Supplies power to the plant for 10 hours |
| | useful sunlight; No power storage is |
| | included |
| Concentrated solar thermal | Supplies hot oil to the plant for 10 hours |
| plant | useful sunlight; Hot oil supply |
| | temperature = 300° C.; No heat storage is |
| | included. |

One of the critical assumptions in Table 1 above is the absolute water content of the ambient air. Briefly, relative humidity (RH) data can be misleading if not correctly understood. For instance, it may appear that an air stream with 40% RH has double the water content of ambient air with 20% RH. However, that is only the case if the conditions are at the same temperature and pressure. This can be seen in Table 2 below, where Condition B has double the water content of Condition A. However, it is also possible for two air streams with 20% RH and 40% RH respectively, to have the exact same absolute water content. This can be seen in Table 2 below, where Condition C at a lower temperature has the exact same water content than Condition A.

TABLE 2
Water content of Air, at a pressure of 101.3 kPa

| | Relative Humidity | Temperature | | Absolute Water Content |
|---|---|---|---|---|
| Condition | (%) | (° C.) | | (g H₂O per kg dry Air) |
| Condition | 20% | 30° | C. | 5.1 |
| A | | | | |
| Condition | 40% | 30° | C. | 10.2 |
| B | | | | |
| Condition | 40% | 18.5° | C. | 5.1 |
| C | | | | |

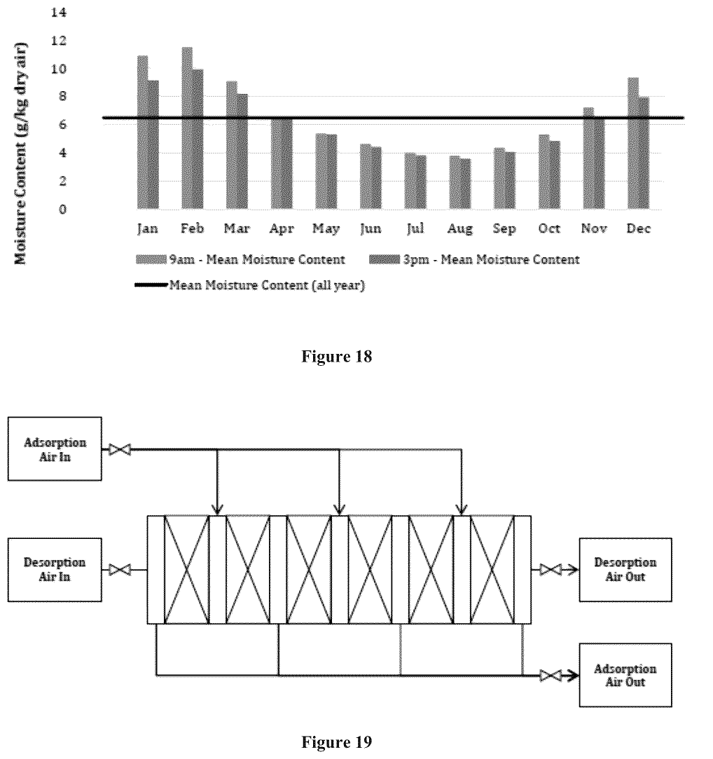

As such, the absolute water content (g H₂O per kg dry Air) is a better measure of air water content. FIG. 18 compares the seasonal variations of water content at the test site for the period of 1969 to 2010. The mean absolute water content assumed for the simulation of the WPU (6.47 g/kg dry air) is also shown on FIG. 18.

Applicant next explored the design philosophy of the WPA. The WPA consists of an adsorption tower containing silica gel; a hygroscopic desiccant medium that has the ability to adsorb water from humid air. The WPA aims to apply temperature swing adsorption to exploit the decrease in water adsorption capacity of silica gel at increased temperatures. The adsorption tower will include an internal heat exchanger to enable desorption of the adsorbed water by using the heat from the hot oil supplied by the concentrated solar thermal plant.

The WPA aims to recover water by using two cycles: an adsorption cycle (during the first cycle, ambient air is sent through the adsorption tower. The silica gel removes water from the humid air; his is performed at ambient conditions (low temperatures), ensuring the silica gel has a large water adsorption capacity); and a desorption cycle (during the second cycle, hot oil is passed through the internal heat exchanger of the adsorption tower; a small flow rate of ambient air is simultaneously sent through the adsorption tower to increase heat transfer from the hot oil to the silica gel; as the silica gel temperature increases, its water adsorption capacity decreases, releasing water vapour; the small flow rate of ambient air also acts as a carrier fluid of the water vapour; the water vapour is recovered by downstream condenser/s).

Additionally, based on concept simulations, it was established that it would be advantageous to: run the adsorption sections in parallel during the adsorption cycle (to achieve a high feed flow rate of air, whilst keeping the pressure drop below 4 kPa); and run the adsorption sections in series during the desorption cycle (to enable high desorption air flow rates which enable high heat transfer, whilst not reducing the water vapour concentration considerably in the condenser feed gas).

Considering the above, a number of adsorption sections can be included into one adsorption tower by employing the arrangement as shown in FIG. 19.

Simulation of a WPA was performed on Aspen Adsorption. Aspen Adsorption is a process simulation software package used to simulate gas-phase adsorption processes such as temperature swing adsorption. The Peng-Robinson equation of state was used for the simulation of the water production assembly.

The table below details the main adsorption bed assumptions entered into Aspen Adsorption for the simulation of the water production assembly.

TABLE 3
Main adsorption bed assumptions - Aspen Adsorption

| | |
|---|---|
| Material balance | Convection only |
| assumption | |
| Material balance | Ergun equation |
| assumption | |
| Kinetic model | Fluid, lumped resistance, linear |
| Isotherm | Langmuir, concentration dependent |
| Energy balance | Non-isothermal with solid |
| | conduction |

Table 4 details the main simulation inputs for the simulation of the water production assembly. The derivation of these values has been iterative with simple optimisation being performed.

Furthermore, the following important inputs were entered into Aspen Adsorption based on literature sources: Mass transfer coefficient of water; Heat of adsorption of water; Specific heat of adsorbent; Thermal conductivity of adsorbent; Water adsorption isotherm parameters of adsorbent.

The heat transfer coefficients were entered into Aspen Adsorption based on fundamental heat transfer calculations. The actual adsorption towers will consist of a large number of adsorption sections (fourteen or more). However, to allow trouble-free simulation convergence, only four adsorption sections were simulated in Aspen Adsorption. The validity of extrapolating simulation results from a reduced number of adsorption sections was proved by comparing the simulation results of one adsorption section to four adsorption sections. As expected, the results (such as water product flow rate per adsorption section and percentage water recovery) were very similar.

TABLE 4
Main simulation inputs - Aspen Adsorption

| Adsorption | 200 | mm |
|---|---|---|
| section height | | |
| Adsorption | 1000 | mm |
| section diameter | | |
| Inter-particle void | 0.4 | |
| Bulk solid density | 677 | kg/m³ |
| of adsorbent | | |
| Adsorbent | 3.57 | mm |
| particle radius | | |
| Adsorption feed | Feed conditions: Temperature = 27.5° C.; Feed | |
| air | pressure = 104.5 kPa (4 kPa differential pressure) | |
| | Discharge conditions: Discharge pressure = 100.5 kPa | |
| | (atmospheric) | |
| | Feed composition: H₂O = 0.010332 kmol/kmol; N₂ = | |
| | 0.780345 kmol/kmol; O₂ = 0.209323 kmol/kmol | |
| | Feed flow rate, per adsorption section: 0.016 kmol/s | |
| | (~0.4 m³/s); Maximum flow rate for a pressure drop of | |
| | 4 kPa (based on Ergun equation) | |
| Desorption feed | Feed conditions: Temperature = 27.5° C.; Feed | |
| air | pressure = 101 kPa (0.5 kPa differential pressure) | |
| | Discharge conditions: Discharge pressure = 100.5 kPa | |
| | (atmospheric) | |
| | Feed composition: H₂O = 0.010332 kmol/kmol; N₂ = | |
| | 0.780345 kmol/kmol; O₂ = 0.209323 kmol/kmol | |
| | Feed flow rate, per adsorption section: 0.0001 kmol/s | |
| | (~0.0025 m³/s) | |
| Cycle times | Adsorption cycle time = 4000 seconds | |
| | Desorption cycle time = 2000 seconds | |
| | Number of full cycles per day (10 hours) = 6 full | |
| | cycles | |
| Heating oil | Feed conditions: Temperature = 270° C. (conservative) | |
| | Feed flow rate, during desorption cycle: 4 kg/s | |
| Condensing | 65° | C. |
| temperature | | |

All the flow rates can be increased and decreased linearly based on the number of adsorption sections. However, the inputs of certain parameters (such as heat transfer coefficients during the desorption cycle) were calculated assuming the adsorption tower consists of fourteen adsorption sections.

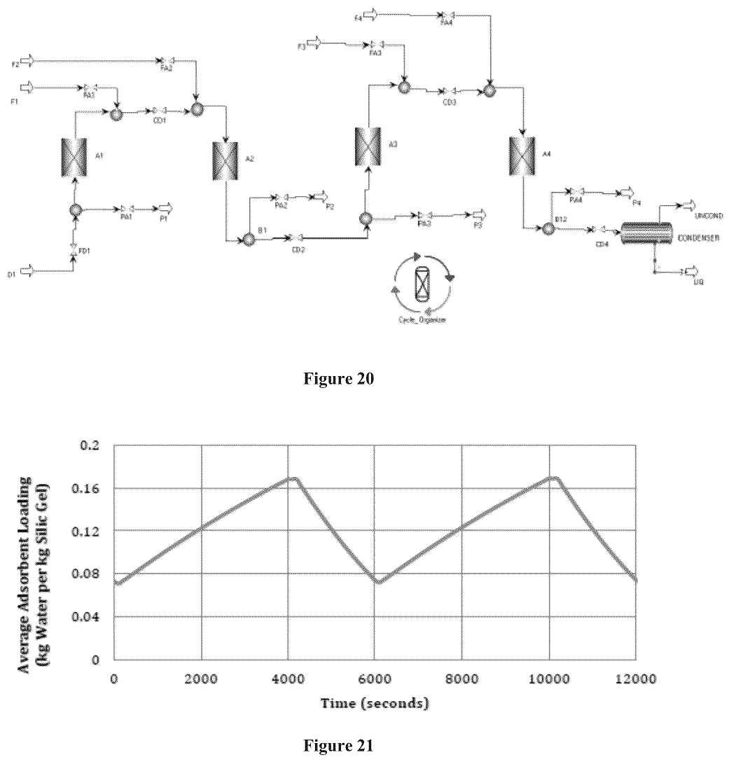

The Aspen Adsorption flowsheet of the WPA is shown in FIG. 20.

The main simulation results based on the inputs shown above are depicted in FIG. 21. FIG. 21 further illustrates the average adsorbent loading for a single adsorption section, based on the simulation results from Aspen Adsorption. It can be seen that adsorption of water from the air onto the silica gel occurs during the initial 4000 seconds, followed by desorption of the water during the next 2000 seconds.

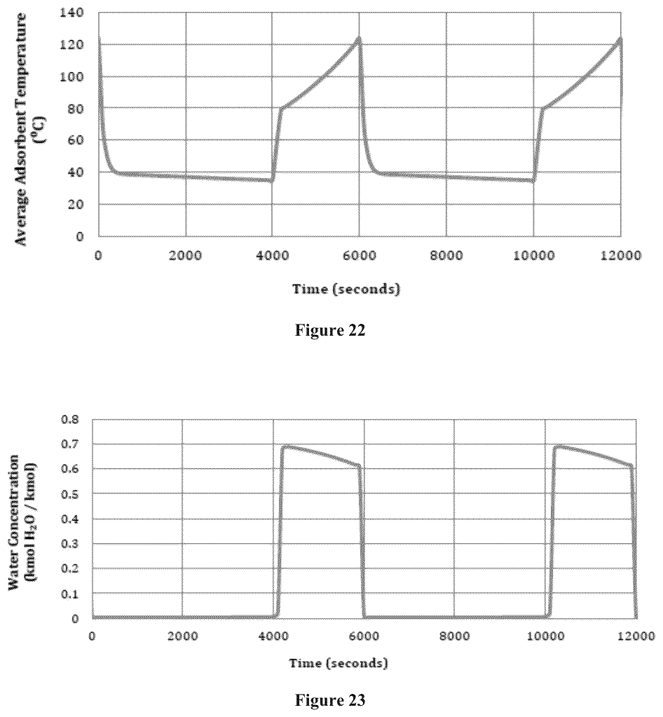

FIG. 22 illustrates the average adsorbent temperature for a single adsorption section, based on the simulation results from Aspen Adsorption. Comparing FIG. 21 and FIG. 22, it can be seen that the increase of adsorbent temperature (due to the hot oil) causes the desorption of the water from the adsorbent. As expected, the detailed results from Aspen Adsorption indicate that there are adsorbent loading gradients and temperature gradients across each adsorption section. These gradients are not shown in FIG. 21 or FIG. 22.

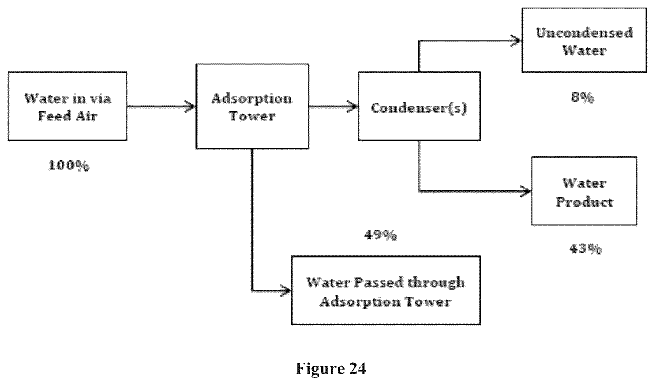

FIG. 23 illustrates the condenser feed gas concentration for four adsorption sections, based on the simulation results from Aspen Adsorption. As shown in Table 4, the condensing temperature was specified as 65° C. Air saturated with water at 65° C. has a concentration of ˜0.25 kmol H₂O per kmol. As the condenser feed gas concentration (shown in FIG. 23) is much larger than 0.25 kmol H₂O per kmol, a large amount of water will condense in the condenser.

A water balance based on the simulation results is illustrated by FIG. 24; the mass of water recovered is approximately 43% of the water in the air fed to the water production assembly.

The main simulation results for one WPA with 14 adsorption sections are shown in Table 5.

TABLE 5
Simulation results of one Water Production
Assembly (14 adsorption sections)

| Water product flow rate | 433 L H₂O per day (10 hour day) | |
|---|---|---|
| Average oil heating duty per WPA | 245 | kW |
| Average condenser duty per WPA | 97 | kW |

| | |
|---|---|
| Number of units required in WPU | 6 × WPA |

To reduce the required size of the condenser(s), the photovoltaic power plant and the concentrated solar thermal plant, the WPAs should be divided up into three banks and sequenced as shown in Table 6. Based on the results in Table 5, above, each adsorption bank will consist of two WPAs.

The oil heating and condenser/s are only required during the desorption cycle. Based on the sequencing shown in Table 6, only one adsorption bank will be in the desorption cycle at any one time. Consequently, the main simulation results for the water production plant are as shown in Table 7, below.

TABLE 6
Sequencing of adsorption banks

| | Adsorption | Adsorption | Adsorption |
|---|---|---|---|
| Time (s) | bank A | bank B | bank C |
| 0-2000 | Absorption | Absorption | Desorption |
| 2000-4000 | Desorption | Absorption | Absorption |
| 4000-6000 | Absorption | Desorption | Absorption |
| 6000-8000 | Absorption | Absorption | Desorption |
| 8000-10000 | Desorption | Absorption | Absorption |
| 10000-12000 | Absorption | Desorption | Absorption |
| — | — | — | — |
| 30000-32000 | Absorption | Absorption | Desorption |
| 32000-34000 | Desorption | Absorption | Absorption |
| 34000-36000 | Absorption | Desorption | Absorption |

TABLE 7
Main simulation results of the Water Production Unit (6 × WPAs)

| | |
|---|---|
| Water product flow rate | >2.5 kL H₂O per day (10 hour day) |
| Average total oil heating | 490 kW |
| duty | |
| Average total condenser | 194 kW |
| duty | |
| Average total power | 156 kW |
| required | |

Worst case simulation results were modelled accordingly. The water product flow rate of the Water Production Unit will vary based on the ambient air water content. To illustrate this, a second simulation was performed using the worst case ambient air water content. Based on historical data at the test site, the month with the lowest mean ambient air water content is August (as shown in FIG. 18). Table 8 compares the differences between the main and the worst case simulation conditions. All the other conditions for the worst case simulation were kept the same as shown above.

TABLE 8
Comparison of main and worst case simulation conditions

| | Main simulation | Worst case simulation conditions; |
|---|---|---|
| | conditions | August |
| Temperature | 27.5° C. | 22.6° C. |
| Absolute water | 6.47 g/kg dry air | 3.65 g/kg dry air |
| content | | |

Next, Table 9 compares the differences between the main and the worst case simulation product water flow rate, assuming both scenarios consist of a Water Production Unit with six Water Production Assemblies. The product water flow rate during the worst case month is ˜60% of the desired water product flow rate of 2500 litre H₂O per day (10 hour day).

To provide a comparison between the current basis and the worst case scenario, the design of the worst case simulation WPU is compared to the design of the main simulation WPU in Table 10.

TABLE 9
Comparison of main and worst case simulation product water
flow rate (both with six Water Production Assemblies)

| | Main simulation | Worst case simulation |
|---|---|---|
| Water product flow | 2602 L H₂O per day | 1543 L H₂O per day |
| rate | (10 hour day) | (10 hour day) |

Based on the comparison in Table 10, it would be expected that the cost of a WPU suitable to produce 2500 litre H₂O per day (10 hour day) at the worst case conditions, would cost ˜40-50% more than the main/average design. This would need to be confirmed with detailed costings.

TABLE 10
Comparison of main and worst case simulation WPU design

| | | Main | Worst case | Size of worst case |
|---|---|---|---|---|
| | | simulation | simulation | WPU relative to |
| | Units | WPU | WPU | main WPU |
| Number of units | — | 6 WPAs | 10 WPAs | 167% |
| required in | | | | |
| WPU | | | | |
| Adsorption feed | m³/s | 22.2 | 37.0 | 167% |
| fan flow rate | | | | |
| Concentrated | kW | 490 | 712 | 145% |
| solar plant | | | | |
| heating duty | | | | |
| Condenser duty | kW | 193 | 201 | 104% |
| Photovoltaic | kW | 156 | 251 | 161% |
| plant power | | | | |
| requirement | | | | |

In conclusion, simulation of a water production assembly was performed on Aspen Adsorption to confirm the technical feasibility of using adsorption towers containing silica gel for the production of water from air by means of solar heat and power. The simulation demonstrated that it is technically feasible to produce water from air at the test site with the assumptions provided above.

According to the simulation, six Water Production Assemblies, each containing fourteen adsorption sections (with diameters=1000 mm and section heights=200 mm) would be required to obtain the desired water production flow rate of 2.5 kL water per day (10 hour day) at the mean ambient conditions at the test site.

Table 11 compares the energy results provided previously to the simulation estimates obtained in the current report; the simulation estimates demonstrate that the concept values used were conservative.

The above data ably demonstrate the efficacy of the water maker when deployed in an and environment such as the test site at Tennant Creek, Northern Territory, Australia. The next step was to obtain simulation data for the integrated water maker and electrolyser. The Fukushima Renewable Energy Institute (FREA) of Japan, in association with the Renewable Energy Research Centre of the National Institute of Advanced Industrial Science and Technology (AIST) performed such modelling, under the supervision of Mr Hirokazu Kojima.

TABLE 11
Comparison of energy results of simulation and the
concept for a Water Production Unit with a product flow
rate of 2.5 kL H₂O per day (10 hour day)

| | Concept | Simulation |
|---|---|---|
| | values | estimates |
| Average total oil heating | 800 kW | ~490 kW |
| duty | | |
| Average total fan power | 160 kW | ~140 kW |
| required | | |

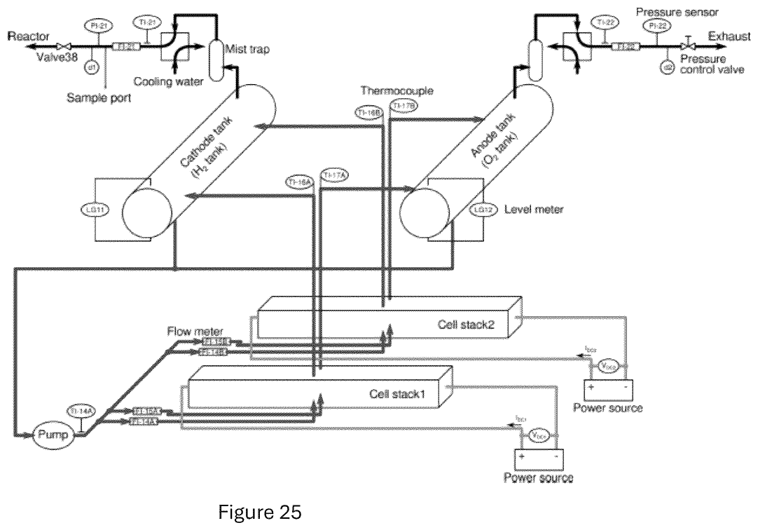

The schematic set up of the alkaline water electrolyser is shown in FIG. 25. The process parameters were as shown in Table 12, below:

TABLE 12
Process parameters of alkaline water electrolyser set up

| Electric power | 150 | kW |
|---|---|---|
| Current density | 4 | kA/m² |
| Number of cells | 41 | cells/stack |
| Number of stacks | 2 | |
| Electrode area | 0.25 | m² |
| Temperature | 80° | C. |
| Electrolyte | 30 | wt % KOH |
| Hydrogen production | 34 | Nm³/h |
| rate | | |

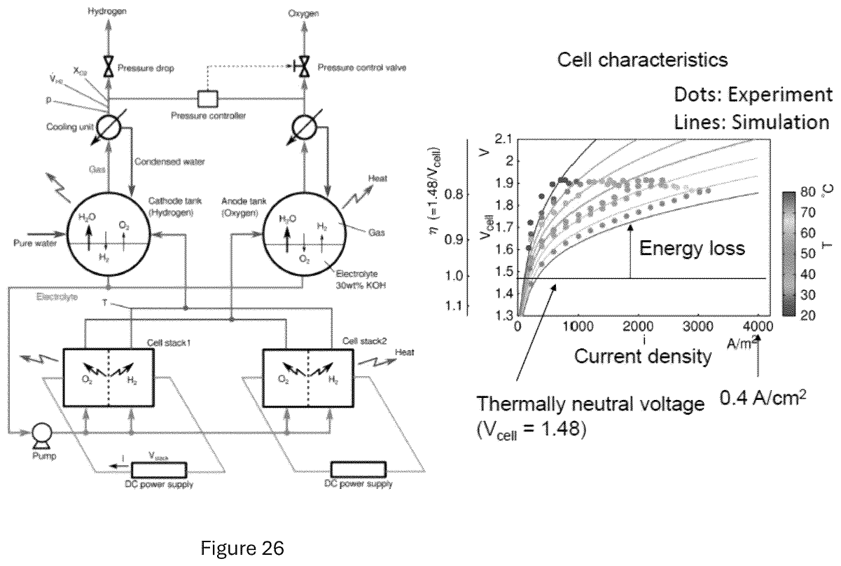

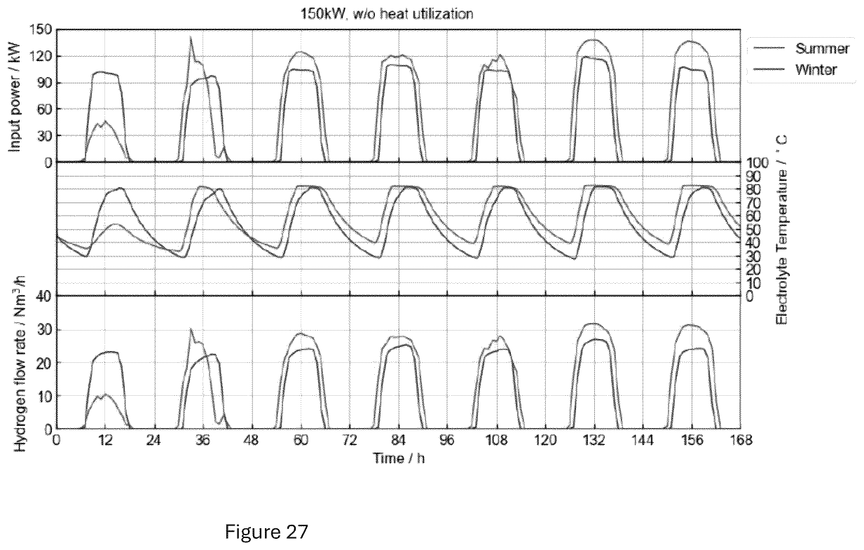

Next, the simulation model is shown in FIG. 26. The simulated conditions are as shown below in Table 13.

TABLE 13
Simulated conditions giving rise to data shown in FIG. 26

| | | Heat | |
|---|---|---|---|
| Run | Scale | utilisation | Power pattern |

| | | | | |
|---|---|---|---|---|
| A | 150 | kW | No | Summer to winter |
| B | 150 | kW | Yes | Summer to winter |
| C | 2.5 | MW | No | Summer to winter |

The input power patterns were: Summer (7 days from 1990 Jan. 1, air temperature: 30° C.); Winter (7 days from 1990 Jul. 1, air temperature: 20° C.). The electrolyte temperature can be raised up to 80° C. using external heat source. Finally, in respect of the scale of model “C”, a 2.5 MW electrolyser was not available, so the calculations were performed with some assumptions, i.e., electrode area=3 m²; Number of cells=57.

FIG. 27 depicts the results of Run A. The data show that temperature increases during operation due to electrolysis energy loss and decreases during shutdown.

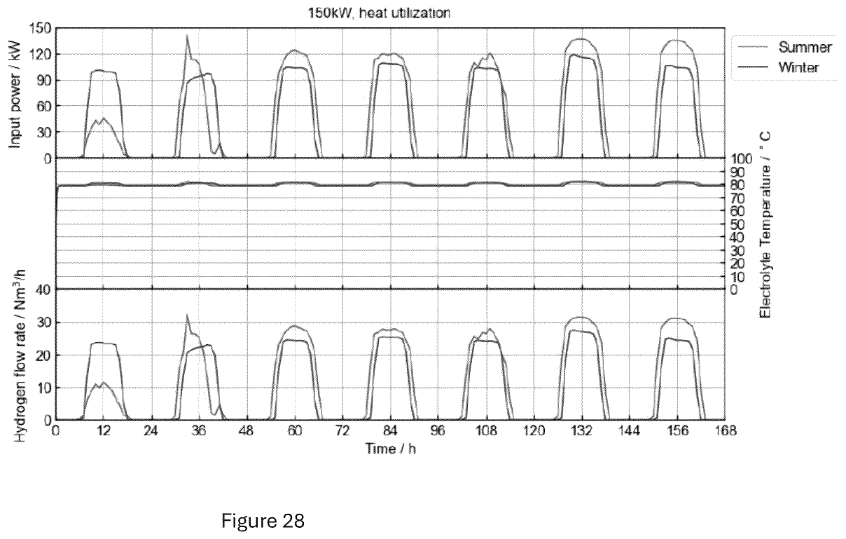

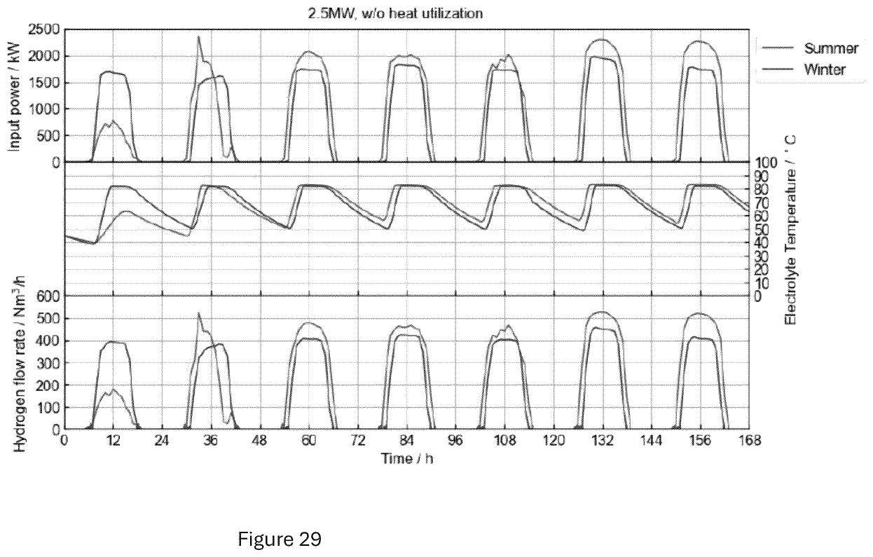

FIG. 28 shows the results of Run B. The data show that if heat is utilised to raise the electrolyte temperature, relatively high efficiency operation can be achieved.

Finally, FIG. 29 shows the results of Run C. The data show that the speed of temperature decrease during shutdown slows significantly.

The overall results are presented in Table 14. The data ably demonstrate that for the parameters tested, higher temperature and lower current density give rise to higher efficiencies.

TABLE 14
Overall results of modelling, demonstrating higher efficiencies
at higher temperature and lower current density

| | | Heat | Power | Electricity | Hydrogen | E/H₂ |
|---|---|---|---|---|---|---|
| Run | Scale | utilisation | pattern | (MWh) | (Nm³) | (kWh/Nm³) |
| A | 150 | No | Summer to | 7.49 to | 1720 to | 4.36 to |
| | kW | | winter | 6.31 | 1430 | 4.41 |
| B | 150 | Yes | Summer to | 7.49 to | 1760 to | 4.25 to |
| | kW | | winter | 6.31 | 1490 | 4.23 |
| C | 2.5 | No | Summer to | 125 to | 29000 to | 4.30 to |
| | MW | | winter | 105 | 23500 | 4.29 |

Energy consumption calculations are based upon data obtained from Beijing SinoHy Energy. For instance, the specifications of an alkaline water electrolysis hydrogen generation module are as shown below in Table 15.

According to the invention the water maker is integrally associated with an electrolyser to generate hydrogen. In a preferred embodiment, the system generates enough electricity for at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% of the energy requirements of the electrolyser.

TABLE 15
Technical specifications for alkaline water electrolysis
hydrogen generation equipment; Beijing SinoHy Energy

| Hydrogen generation | 10 | Nm³/h |
|---|---|---|
| capacity | | |
| Oxygen generation capacity | 5 | Nm³/h |
| Hydrogen purity | 99.8% | |
| Oxygen purity | 99.5% | |
| Working pressure of | 3.2 | MPa |
| electrolyser | | |
| Power consumption | ≤4.8 | kWh/Nm³ |

Typically, in practice, depending upon the environment in which it is deployed, it is envisaged that the system will generate about 5-60% of the energy requirements of the electrolyser.

In a preferred embodiment, hydrogen from the electrolyser is used in an ammonia plant, preferably a green ammonia plant. In a preferred embodiment, the hydrogen from the electrolyser is used in a methanation plant. In a preferred embodiment, the hydrogen from the electrolyser is used as a fuel source. In a preferred embodiment, the hydrogen is used in a fuel cell.

In an embodiment, oxygen is produced as part of the electrolysis process as an oxygen by-product and retained for future use.

In an embodiment, the oxygen by-product is used to increase the efficiency of a wastewater treatment plant.

In an embodiment, the system further comprises a fuel cell to use the hydrogen to produce electricity and a water by-product.

In an embodiment, the fuel cell uses oxygen from the ambient air to generate electricity and a water by-product.

In an embodiment, the fuel cell uses the oxygen by-product to generate electricity and water by-product.

In an embodiment, the water by-product is mineralised to be suitable for human consumption.

In an embodiment, the water by-product is stored for later use in the electrolyser.

In an embodiment, the water by-product is injected into an underground aquifer.

In an embodiment, the system comprises insultation to maintain temperature overnight or during shut down periods, and/or to minimise heat loss overnight or during shut down periods.

In an embodiment, the efficiency of hydrogen production is in the region of about 3.9 to 4.4 kWh/Nm³, more preferably, about 4.23-4.25 kWh/Nm³ (47.0-47.2 kWh/kg).

In an embodiment, the efficiency of hydrogen production is increased by at least 5, 6, 7, 8, 9, 10, 11, 12, 13, 14, 15, 16, 17, 18, 19, or at least 20%, preferably at least 5, 10, 15, or 20%, preferably at least 7 to 13%.

In a preferred embodiment, oxygen produced by the electrolyser is exhausted into the atmosphere. In an alternative embodiment, oxygen produced by the electrolyser is retained in the system and used in a fuel cell with hydrogen.

In a preferred embodiment, oxygen produced by the electrolyser is exhausted into a waste treatment plant for use in aerobic treatment of the biomass. Oxygen is bubbled through the biomass, increasing the aerobic efficiency of the biomass being treated.

Water produced in the water maker is not potable as the water has not been mineralised, which, if consumed by a human, would strip the minerals from the body. Therefore, any water obtained from the fuel cell must be treated before it is suitable for human consumption. In a preferred embodiment, the water produced by the water maker is mineralised to make it suitable for human or animal consumption. Methods and systems of mineralising water are known to those of skill in the art.

A key issue with water storage around the world, particularly in Australia, is solar and wind caused evaporation. There is a very high need to minimise evaporation losses of water stored for later use. Therefore, one solution to store water is to inject into underground reservoirs for storage and later use. This would naturally mineralise the water so that it would be suitable for human consumption at a later date. In an alternative embodiment, water produced by the water maker is injected into an underground aquifer. Advantages to this injection include remineralisation with environmental minerals and salts present in the surrounding rocks of the aquifer. Additionally, injection into the aquifer avoids evaporation the water produced by the water maker, increasing the downstream utilisation of water produced by the water maker.

One key advantage of the present invention is the potential for multiple points of electricity generation within the system such that the energy produced may be enough to run the system, preferably with some electricity left over for either returning to the power grid or to be used in downstream applications, such as an electrolyser to produce hydrogen, green ammonia production, a carbonation reactor or any other downstream energy requirement.

Those skilled in the art will appreciate that the invention described herein is amenable to variations and modifications other than those specifically described. It is understood that the invention includes all such variations and modifications which fall within the spirit and scope of the present invention.

The present invention also relates, in various embodiments, to technology configured to enable improved operation of electrolyser-based hydrogen generation systems. For example, the technology has been developed to operate in a scenario where an electrolyser system is powered via a renewable energy source, such as one or more photovoltaic cells, tidal, wind, geothermal or other renewable energy resource. In some embodiments, the technology provides arrangements which inhibit reverse operation of an electrolyser as a result of input voltage drop. Other embodiments additionally/alternately provide for improved electrolyser cell management, thereby to better account for variations in renewable energy production. While some embodiments will be described herein with particular reference to those applications, it will be appreciated that the invention is not limited to such a field of use, and is applicable in broader contexts.

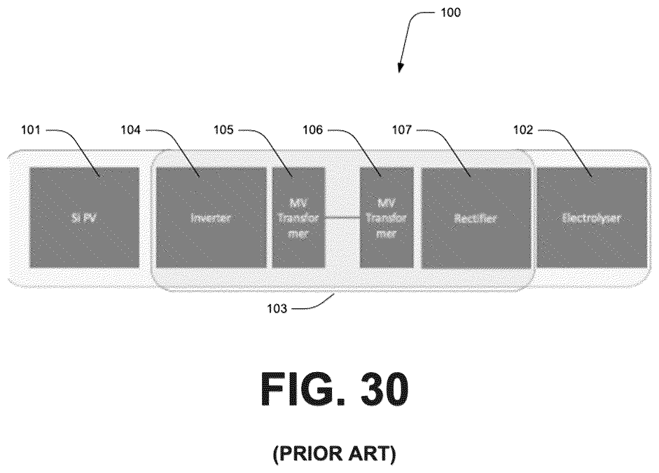

FIG. 30 illustrates a prior art hydrogen generation system 100. A solar power source in the form of a photovoltaic array 101 is used to supply electrical power to an electrolyser subsystem 102. Electrolyser subsystem 102 includes one or a plurality of electrolyser components, in the form of distinct electrolyser cells, which each operate to perform electrolysis for the generation of hydrogen in response to an input voltage supplied via photovoltaic array 101.

A power supply management arrangement 103 is interposed between photovoltaic array 101 and electrolyser subsystem 102. This includes, in an upstream direction commencing at the photovoltaic array: an inverter 104 coupled to a first medium voltage transformer 105, and a second medium voltage transformer 106 coupled to a rectifier 107. This power supply management arrangement 103 is operated to control input voltage applied to the electrolyser subsystem. In that regard, the conversion capacity of an electrolyser subsystem is governed by the output voltage and power output of the photovoltaic array. More specifically, the voltage output of the array multiplied by the maximum bus bar current provides the electrolyser size.

Whilst the prior art system of FIG. 30 has proven operational effectiveness, there are considerable cost factors associated with the power supply management arrangement 103. The present inventors have identified that considerable capital cost savings are able to be made by adopting alternate system configurations, and that these can be realised without substantively jeopardising generation efficiencies or operational safety.

Embodiments described below reference both methods for configuration of electrolyser-based hydrogen generation system, and systems themselves. It will be appreciated that various modifications can be made to such methods and systems within the context of core concepts which are taught herein.

The term “electrolyser-based hydrogen generation system” refers to a system which is configured to perform electrolysis of water thereby to generate hydrogen, for instance such that the hydrogen may be used for future energy-related applications. An electrolyser-based hydrogen generation system includes an electrolyser subsystem (for instance a PEM electrolyser or an alkaline electrolyser, preferably an alkaline electrolyser) across which an input voltage is applied by a power source. The electrolyser substance includes one or more electrolyser components, which for the purposes of the remainder of this description are referred to as “electrolyser cells” or simply “cells”.

In examples described below, the power source is a solar power source (for example a photovoltaic array, or concentrated photovoltaic array). It will be appreciated that other forms of power source may be present in further embodiments, including by not limited to other forms of renewable energy (such as wind, tidal, geothermal, gravitational water flow, and others).

More specifically, embodiments are described by reference to a photovoltaic array in the form of an axis tracking array, preferably a dual axis array. Preferably, this is configured such that a voltage output from the solar power source may be modulated by altering the angle of incidence of sunlight on the power source. In an embodiment, the voltage output may be modulated to ensure that the correct voltage is supplied to the electrolyser subsystem, based on optimal electrolyser subsystem voltage requirements. As discussed in more detail below, some embodiments include electrolyser subsystems having multiple discrete cells which are able to be activated and deactivated for optimisation relative to current and/or predicted solar power generation parameters.

In some embodiments, the electrolyser subsystem is formed of a series of discrete cells, which are configured in a manner that allows each to operate independently of the others. These cells can be operable at the same or different voltages, thereby to ensure optimal operation of the electrolysers when matched to an appropriate power supply. This is significant in the context of renewable energy power supplies, such as solar, as there can be voltage and/or current fluctuations which can affect the electrolysers performance. Various embodiments described further below are optionally configured such that the electrolyser subsystem includes a plurality of cells matched to the predicted and/or actual measured area of an output graph of voltage against time at a given solar power generation site (or other renewable energy). For instance, a preferred approach is for the match to be least 60% of the area under the graph. It is preferable to have a better optimised match, for example preferably at least 65%, 70%, 75%, 80% or more. Some embodiments provide a match of greater than 85%, 90%, or even 95% of the area under the graph.

One class of embodiments includes methods for configuring electrolyser-based hydrogen generation systems thereby to inhibit reversion of one or more electrolyser components within the electrolyser subsystem to fuel cell operation. The methods include configuring a connection between the power source and the electrolyser subsystem such that: (i) there is no conversion between DC and AC power; and (ii) reverse current flow from the one or more electrolyser components within the electrolyser subsystem is inhibited in the event that the input voltage is reduced or removed. That is, in some embodiments active steps are taken in the configuration (e.g. construction and commissioning) of the system such that, upon a drop of the input voltage supplied by the power source, reverse current flow through the electrolyser subsystem (i.e. through one or more cells of the electrolyser subsystem) is inhibited, or more preferably prevented, without the intervention of components which manage conversion between DC and AC power (for example DC to AC, followed by AC to DC).

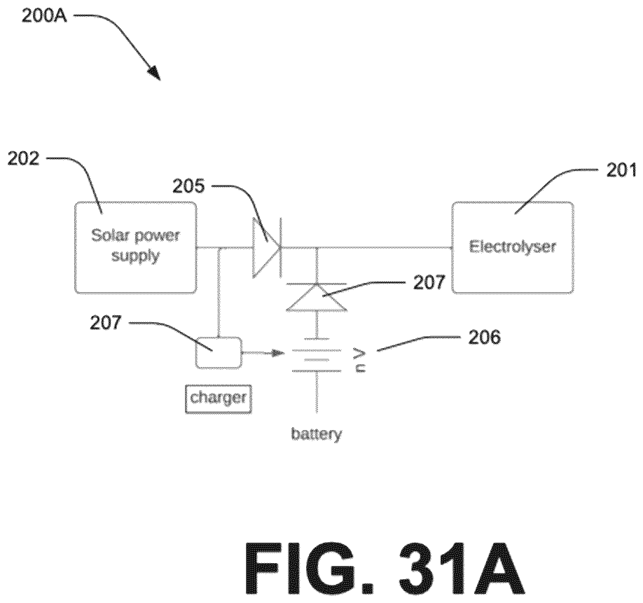

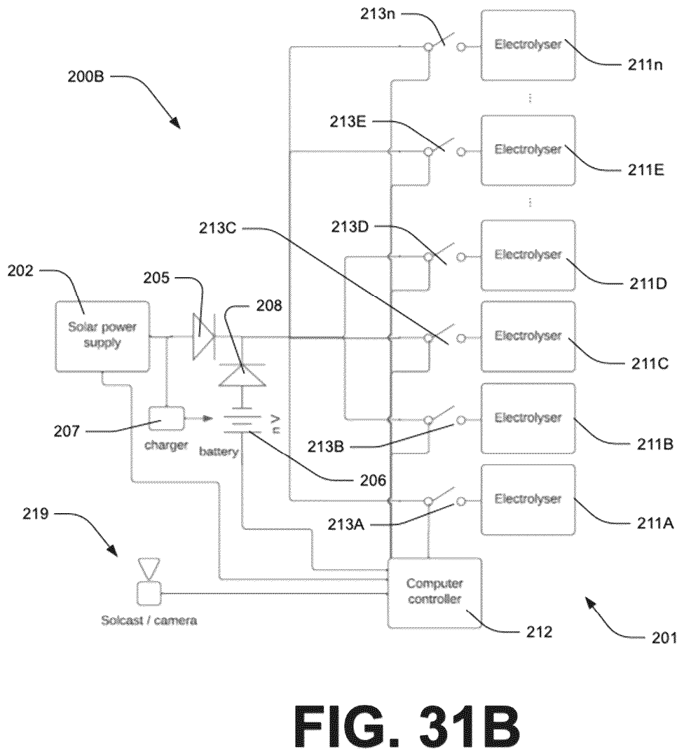

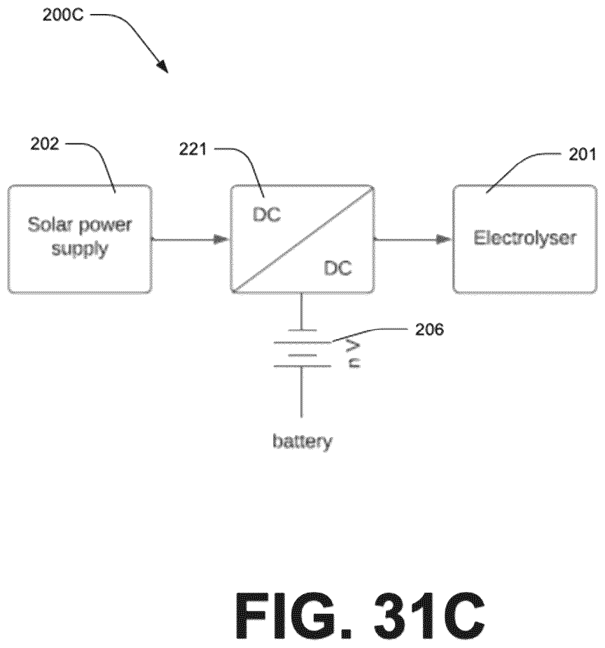

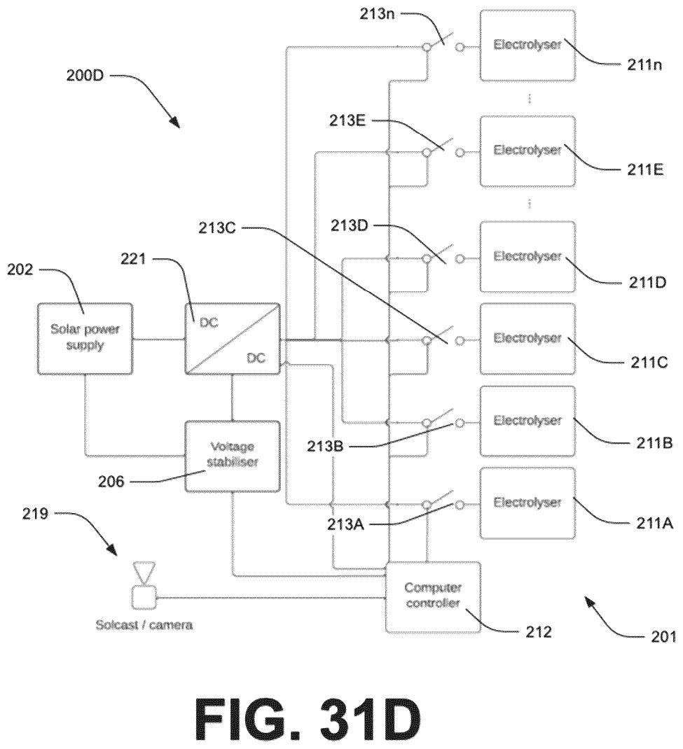

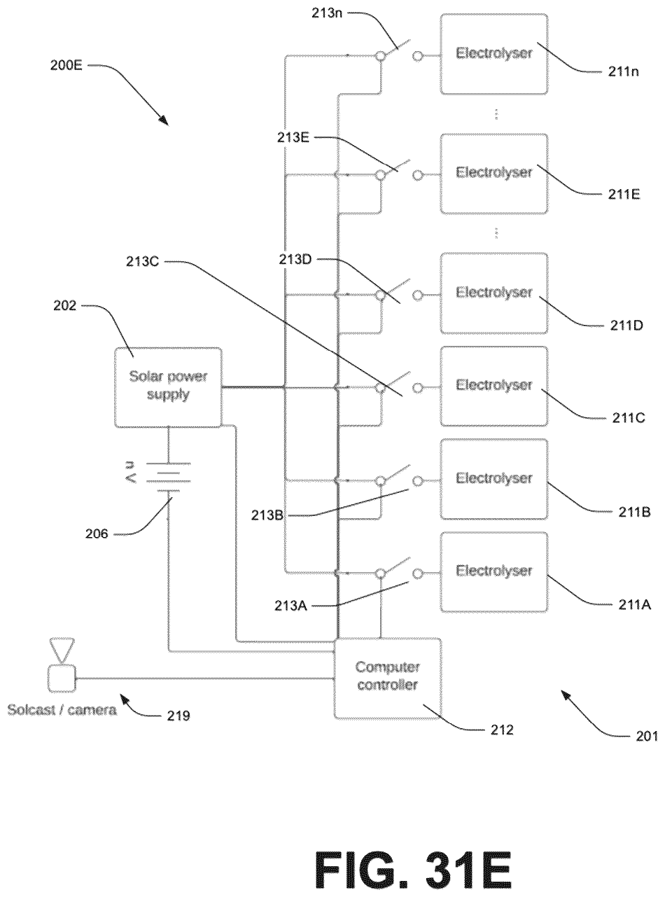

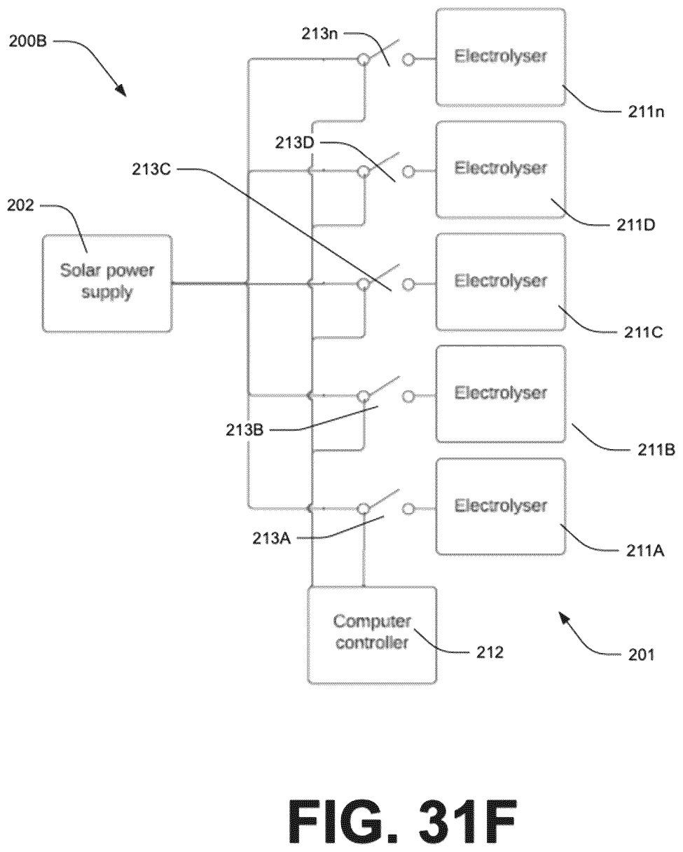

In some embodiments, configuring the connection between the power source and the electrolyser subsystem includes configuring one or more components to function as diodes downstream of the electrolyser subsystem, thereby to inhibit reverse current flow from the one or more electrolyser components within the electrolyser subsystem. An example is provided by FIG. 31A, as described below.

FIG. 31A illustrates an electrolyser-based hydrogen generation system 200A including an electrolyser subsystem 201 across which an input voltage is applied, the input voltage being provided by a power source in the form of a solar power supply 202. Although solar power supply 202 is shown (and the subject of embodiments described herein), other renewable power supplies are also able to be used in the present invention, such as, wind, tidal, geothermal, gravity fed water generation and the like. In this embodiment, system 200 is configured by installing one or more diodes downstream of the electrolyser subsystem, intermediate power supply 202 and the electrolyser subsystem 201. As illustrated, first diode 205 is interposed directly between the power supply 202 and electrolyser subsystem 201. Diode 205 prevents reverse flow of electricity into the power supply, and hence inhibits reverse power flow through electrolyser subsystem 201. The configuration shown in FIG. 31A further includes, in conjunction with the one or more diodes, an optional voltage stabiliser downstream of the electrolyser subsystem, intermediate the power supply and the electrolyser subsystem, the voltage stabiliser being adapted to stabilise the voltage. As illustrated, the voltage stabiliser is a battery 206, which is charged via an optional charger component 207, which draws from the power supply 202. A second diode 208 is interposed upstream of battery 206, downstream of electrolyser subsystem 201. In this manner, the battery is able to provide a baseline input voltage to the electrolyser subsystem in the event that there is a sudden loss of solar power generation. In some embodiments the system is configured thereby to initiate a controlled shutdown of the electrolyser subsystem responsive to the battery reaching a threshold minimum level of charge. Such a shutdown may also in some embodiments be initiated in response to other factors, for example input voltage prediction based on renewable resource monitoring, as discussed in more detail further below.

In an alternate embodiment, the method of configuring the system includes configuring one or more other components to function as diodes downstream of the electrolyser subsystem. For example, in one example the power source includes a photovoltaic array, and the one or more components configured to function as diodes downstream of the electrolyser subsystem include the photovoltaic array itself.

FIG. 31B illustrates an embodiment where the diode/battery/charger combination of FIG. 31A is extended to provide electrolyser cell optimisation attributes, illustrated as system 200B. The electrolyser subitem 201 includes a series of discrete cells 211A to 211n, which are configured in a manner that allows each to operate independently of the others. These cells can be operable at the same or different voltages, thereby to ensure optimal operation of the electrolysers when matched to an appropriate power supply. A computer controller device 212 is configured to control operation of the electrolyser cells 211A to 211n. This includes either or both of the following:
(i) Controlling a plurality of switches 213A to 213n which are each respectively associated with a given one of discrete cells 211A to 211n. When a switch is disconnected, there is no potential of reverse current flow from that cell in the remainder of the system.
(ii) Controlling start-up/shutdown procedures for each of discrete cells 211A to 211n.

Preferably the computer controller is configured to implement a start-up process of a given cell, and closes the switch to connect that cell only after that start-up process is completed. Likewise, a switch is opened to disconnect a cell only after a managed shutdown process completes.

Computer controller 212 includes a processor and associate memory module, such that the computer controller is configured to software instructions contained on the memory module. The controller may operate in an entirely standalone capacity, or be responsive to user input/control (for example via a local terminal and/or via a remote terminal and networked connection).

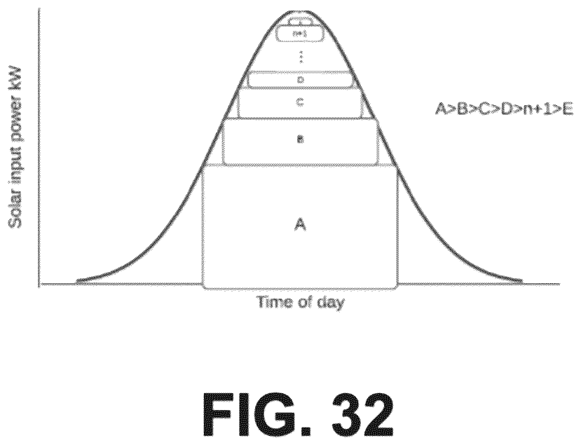

In this example, computer controller 212 is configured to operate the plurality of cells such that operation is matched to the predicted and/or actual measured area of an output graph of voltage against time for the output of solay power supply 202. For instance, a preferred approach is for the match to be least 60% of the area under the graph, preferably at least 65, 70, 75, 80, 85, 90, or 95% of the area under the graph. This is preferably facilitated by providing cells of varying sizes (in terms of conversion capacity). Hence these are able to be activated in a stacked manner of cascading operation as shown in FIG. 32, which includes blocks representative of cells A, B, C, D, n+1 and E, each diagrammatically illustrated by blocks having sizes representative of relative conversion capacities. The chart of FIG. 32 shows how this stacked cascading operation over the course of a “normal” day can be managed for optimisation of total conversion capacity against the output of the solar array (shown as solar input power in FIG. 32).

In the embodiment of FIG. 31B, computer controller 212 controls operation of the cells based not only on “normal” daily fluctuations (as shown in FIG. 32), but additionally based on predictions of irregular variations. This enables the controller to execute one or more predefined algorithms which enable control over subsystem 201 and/or system 200 based on real-time input data. For instance, the input data may include data which enables measurement and prediction of a voltage output of solar power supply 202. Any one or more of the following inputs 219 may be present:
(iii) A sensor which monitors current output voltage from power supply 202.
(iv) A camera subsystem which is configured to monitor cloud cover in one or more predefined approach zones (e.g. via ground and/or satellite cameras), thereby to enable predictions in relation to future variations in solar activity (and hence associated voltage variations in the output voltage of power supply 202).
(v) A connection to an Internet data source, such as Solcast, which provides real-time information for target locations in respect of incoming cloud cover, thereby to enable predictions in relation to future variations in solar activity (and hence associated voltage variations in the output voltage of power supply 202).
(vi) Inputs from one or more other weather sources, for example including wind. By way of example, knowledge of current wind conditions (including surface wind and/or high altitude wind) may be used to assist in predictions of rate and/or direction of cloud cover movement.
(vii) Data representative of daily and seasonal variations in solar activity.
(viii) Where the solar array has a controllable angle of incidence, current/predicted relationship between angle of incidence and optimal angle of incidence, thereby to enable adjustment to predicted voltage output relative to solar activity predictions.

By way or example, in some embodiments an algorithm is configured to identify presence of clouds in image frames (e.g. satellite and/or camera), and from this track movement of clouds between frames thereby to enable prediction of velocity (including direction). This is combined with data representative of sun position relative to solar infrastructure (e.g. based on time and date). From this a relationship between predicted future cloud location and sun location are able to be calculated, thereby to predict times are which cloud cover will affect solar power supply 202.

As a result, an operational optimisation algorithm implemented by controller 212 is configured to predict solar array output for a future period (for example, on a 5 minute basis, 15 minute basis, 30 minute basis and/or 60 minute basis), determine an optimal conversation capacity for that period, and determine an optimal sequence of activation/deactivation steps for individual cells to best match conversion capacity to solar array output. In a preferred embodiment, the algorithm is configured to implement a process which balances number of activation/deactivation procedures against level of matching (for example requiring at least a 5% increase in matching effectiveness for each activation/deactivation procedure required).

As noted, utilisation of renewable energy in the form of solar is an example only. In further embodiments which utilise other forms of renewable energy, alternate inputs are used thereby to enable prediction of future energy production. For example, in the case of wind power, various inputs may be configured to enable prediction of future wind variations. These may include: (i) wind meters are known locations; (ii) Internet sources which provide current wind observations; and (iii) Internet sources which future current wind modelling/predictions.

In a preferred embodiment, where a battery is used to provide a stable base-load to manage unexpected fluctuations in renewable energy input, the voltage supplied by the battery is at least 10 kW, preferably 20, 30, 40, 50, 60, 70, 80, 90, 100, 150, 200, 250, 300, 350, 400, 450, or 500 kW. In an embodiment, the voltage supplied by the battery is at least 10 kW per electrolyser, preferably 20, 30, 40, 50, 60, 70, 80, 90, 100, 150, 200, 250, 300, 350, 400, 450, or 500 kW per electrolyser. In an embodiment, the voltage supplied by the battery is at least 10 kW per cell of the electrolyser, preferably 20, 30, 40, 50, 60, 70, 80, 90, 100, 150, 200, 250, 300, 350, 400, 450, or 500 kW per cell of the electrolyser. In some embodiments, the voltage is between 200 and 350 kW per electrolyser, preferably between 250 and 350 kW or preferably between 275 and 300 kW per electrolyser.

FIG. 31C illustrates a further example, in the form of system 200C, which is similar to the example of FIG. 31C, but includes a DC-DC converter 221 in place of diode 205. The DC-DC converter is positioned between solar power source 202 and the electrolyser subsystem 201. In the illustrated example, the DC-DC converter further comprises a voltage stabiliser, in the form of battery 222 which is adapted to stabilise the voltage. Although not shown in the diagram, in some embodiments, this battery is charged by the solar power source.

The DC-DC converter is configured to monitor the bus bar voltage of the solar power supply (or, in other embodiments, alternate form of renewable energy production system), and operate in a manner which manages fluctuations in the electrolyser subsystem's input voltage such that stable operation is facilitated. The present inventors have identified a DC-DC converter is a purpose built electronic device that precisely controls voltage levels from input side to output side of the converter, which inhibits reverse flow in a similar manner to a diode, and is hence suitable for such a purpose.

In a preferred embodiment, the DC-DC converter manages the maximum power point tracking (MPPT) of the solar power source in order to match the power ratio with the electrolyser subsystem. Preferably, the DC-DC convertor manages any fluctuations in voltage from the solar power source, thereby to provide a steady voltage to the electrolyser.

FIG. 31D illustrates a system 200D, in which the DC-DC converter of FIG. 31C is incorporated into a multi-cell arrangement as per FIG. 31B. It will be appreciated that computer controller 212 is able to operate in substantially the same manner thereby to match conversion capacity to actual/predicted input voltage, although with additional optimisation possible given voltage stabilisation achieved through the operation of the DC-DC converter 221. That is, input voltage to the cells can be modified in a more predictable stepwise manner, thereby to match with operation of switches to connect/disconnect individual cells.

FIG. 31E illustrates a further example system 200E. This is similar to system 200D, however the DC-DC converter is omitted. As such, the solar power supply is connected directly to cells 211A-211n (via switches 213A-213n), and also to computer controller 212 and battery 206 (which is kept charged to provide backup power to controller 212). In this embodiment, switches 213A-213n are used to prevent reverse current flow, under the control of computer controller 212. Further, computer controller 212 applies an optimisation algorithm as discussed above, based on inputs 219, thereby to control start-up, shutdown, connection and disconnection of cells 211A-211n in response to observed and predicted output of solar power supply 202. Predictive functionalities are omitted in the example of FIG. 31F, which illustrates a system 200F, being similar to system 200E but omitting inputs 219.

It will be appreciated that the disclosure above provides for improved hydrogen generation electrolyser systems, and improved configuration of existing systems.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure, for example in relation to the operation of computer controller 212, may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

A system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognise that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A hydrogen production system comprising an atmospheric water capture apparatus operatively associated with an electrolyser, wherein:
a supply of water available for electrolysis;
a heat source is available to maintain electrolyte within the electrolyser at optimal temperatures;
optionally, a source of cooling air from air outlets of the water capture apparatus to cool the electrolyser where overheating may be occurring; and
a source of water for cooling prior to injection into the electrolyser.

2. A system according to claim 1, wherein the efficiency of hydrogen production is in the region of 4.23-4.25 kWh/Nm³ (47.0-47.2 kWh/kg).

3. A system according to claim 1, wherein the atmospheric water capture apparatus produces water, at least some of which is used for cooling a solar cell prior to injection into the electrolyser.

4. A system according to claim 1, wherein the step of collecting atmospheric water, comprises the steps of:
a water absorption step, itself comprising:
providing incident air to a reaction chamber, the air having an initial relative humidity, wherein the reaction chamber is provided with at least one desiccant;
associating the incident air with the desiccant, wherein the desiccant functions to lower the relative humidity of the incident air over a predetermined period, thereby providing dried air and spent desiccant; and
exhausting the dried air to the atmosphere;
a desiccant regeneration step, itself comprising:
providing heating means at least partly communicable with the reaction chamber to provide heating thereto; and
regenerating the spent desiccant by heating via the heating means to generate steam and regenerated desiccant;
a steam condensation step, itself comprising:
the steam being passed into a condenser, the condenser being communicable with the reaction chamber, and subsequently condensed to water; and
harvesting the water.

5. A system according to claim 1, wherein oxygen is produced as part of the electrolysis process as an oxygen by-product and retained for future use.

6. A system according to claim 1, wherein the system further comprises a fuel cell to use the hydrogen to produce electricity and a water by-product.

7. A system according to claim 6, wherein the water by-product is mineralised to be suitable for human consumption.

8. A system according to claim 6, wherein the water by-product is stored for later use in the electrolyser.

9. A system according to claim 6, wherein the water by-product is injected into an underground aquifer.

10. A system according to claim 1, wherein the system comprises insultation to maintain temperature overnight or during shut down periods, and/or to minimise heat loss overnight or during shut down periods.

11. A system according to claim 1, wherein the efficiency of hydrogen production is increased by at least 5, 6, 7, 8, 9, 10, 11, 12, 13, 14, 15, 16, 17, 18, 19, or at least 20%, preferably at least 5, 10, 15, or 20%, preferably at least 7 to 13%.

12. A system according to claim 1, wherein the heat source derives thermal energy from renewable means selected from a solar array, a mirrored array, a solar thermal array, geothermal energy, waste heat (for example from a power station, refinery, smelter, server farms, etc.), or any other one or more source/s of heat.

13. A system according to claim 4, further comprising the step of actively cooling the heated regenerated desiccant by passing further incident air over the heated regenerated desiccant until it cools and/or becomes re-spent.

14. A system according to claim 1, further comprising the step of actively cooling the heated regenerated desiccant by passing the dried air over the heated regenerated desiccant until it cools prior to commencing of a further cycle of the method.

15. A method for configuring an electrolyser-based hydrogen generation system, wherein the system includes an electrolyser subsystem across which an input voltage is supplied by a power source, thereby to inhibit reversion of one or more electrolyser components within the electrolyser subsystem to fuel cell operation, the method including: configuring a connection between the power source and the electrolyser subsystem such that:
(i) there is no conversion between DC and AC power; and
(ii) reverse current flow from the one or more electrolyser components within the electrolyser subsystem is inhibited in the event that the input voltage is reduced or removed.

16. A method according to claim 15 wherein configuring the connection between the power source and the electrolyser subsystem includes configuring one or more components to function as diodes downstream of the electrolyser subsystem, thereby to inhibit reverse current flow from the one or more electrolyser components within the electrolyser subsystem.

17. A method for optimising operation of an electrolyser-based hydrogen generation system, wherein the system includes an electrolyser subsystem to which power is supplied by a renewable power source, wherein the electrolyser subsystem includes a plurality of discrete electrolyser components, the method including:
maintaining data representative of capacity of each of the plurality of discrete electrolyser components;
receiving input representative of predicted future power output of the renewable power source, wherein the predicted future power output is determined based on processing of real-time weather monitoring and/or forecasting data;
based on the predicted future power output for a defined time, executing an algorithm thereby to select a subset of the plurality of discrete electrolyser components, thereby to match electrolyser capacity within a threshold range of predicted future power output; and
controlling start-up and/or shut-down procedures amongst the plurality of discrete electrolyser components, thereby to configure the system such that the subset of the plurality of discrete electrolyser components are operational at the defined time.

18. A method according to claim 17 wherein the select a subset of the plurality of discrete electrolyser components is responsive to an algorithm which balances a number of required activation/deactivation procedures relative to a preceding period against level of matching of electrolyser capacity within a threshold range of predicted future power output.

19. A method according to claim 17 wherein the predicted future power output of the solar power source is based on data representative of a combination of any two or more of the following: time; date; solar power source location; and cloud cover.

20. A method according to claim 17 wherein the renewable power source includes a wind power source.
